(19) United States
(12) Patent Application Publication
(10) Pub. No.: US 2016/0260044 A1
(43) Pub. Date: Sep. 8, 2016

(54) SYSTEM AND METHOD FOR ASSESSING PERFORMANCE METRICS AND USE OF THE SAME

(71) Applicant: MONA SABET, (US)

(72) Inventors: MONA SABET, SAN CARLOS, CA (US); Matthew Hayward, Burlingame, CA (US); Ilya Dreytser, CANTON, MA (US)

(21) Appl. No.: 15/056,950

(22) Filed: Feb. 29, 2016

Related U.S. Application Data
(60) Provisional application No. 62/127,960, filed on Mar. 4, 2015.

(51) Int. Cl. G06Q 10/06

(52) U.S. Cl. CPC G06Q 10/06398

(57) ABSTRACT

A system and method for assessing performance by generating performance analytics metrics are described. The system takes inputs that are performance indicators, performs analytics and processes results immediately to provide personalized performance metrics and group performance metrics. The system and method describe an effective way of obtaining and processing data used to calculate performance metrics, and useful outcomes from the analyzing and processing of the performance metrics. The system described provides visibility and transparency about performance management to individual using the system and to groups such as workforce participants and may be used by individuals and groups to guide them towards better performance outcomes.

### CROSS REFERENCE TO RELATED APPLICATION

This application is a utility application of a U.S. Provisional application 62/127,960 filed on 4 Mar. 2015. The Provisional application 62/127,960 is hereby incorporated by reference in its entireties for all its teachings.

### FIELD OF TECHNOLOGY

The present invention relates generally to a system and method for assessing a performance metrics. Performance metrics are generated and processed using interaction and relationship profiles, feedback inputs, and career trajectory over time by combining aggregate data for a person and across many persons. More specifically performance analytics metric (PAM) identifies the typical career trajectory and the competencies, skills, and timelines adherent to obtaining career objectives for a person.

### BACKGROUND

Effective performance evaluation of workforce participants is a critical but challenging objective. Transparency and visibility of how well a worker performs is critical because top performers typically cannot describe what they do differently from everyone else, and underperformers would prefer to be more successful but do not have analytics that help them assess how to achieve that success. Existing solutions fail in a number of areas.

Commonly used performance management tools are periodic surveys and written evaluations, such as 360 feedbacks, and performance management software that requires employees to input past goals, then much later identify projects completed and map them against those goals, and define their strengths and areas for growth.

The problem with these systems is that they require reflection long after the activities undertaken by the employees (asynchronous reflection). Asynchronous reflection causes many problems: (1) it is difficult for people to imagine what they want in the future or recall what they did or how they felt about a person in the past, (2) because the value derived from the reflection isn't timely, it could suffer from inaccuracy and any benefit it generates is delayed and the feedback can't be applied to the actual activity that generated it, (3) the effort involved in asynchronous reflection and the delayed benefit causes friction that makes it less likely workers and their colleagues and managers fully engage with the system.

“Pulse survey” systems have been more recently developed to reduce the problems arising from asynchronous reflection. Pulse survey solutions allow workers to send questions to colleagues or customers asking for real-time feedback.

While the pulse survey can be used to solve the asynchronous reflection problem of periodic evaluations, it continues to be burdened by a problem of evaluation inertia. Evaluation inertia arises when a person is required to ask for feedback or write out feedback. It is very difficult for people to request feedback and so any system that requires an individual to generate a feedback request will have reduced participation. It is also difficult for people to give thoughtful and honest feedback, partly because it requires carefully constructed communication, which takes effort on the part of the evaluator, and partly because people naturally avoid tension that can arise by giving negative feedback, resulting in either avoidance of giving feedback or unrepresentative feedback responses. Surveys that only require evaluators to choose one of agree/disagree are examples of feedback methods that reduce the inertia created by requiring carefully constructed communication.

Performance comparison reports often give workers being evaluated a ‘score’ and shows them how their scores compare against others in a particular cohort such as a team or department. The problem with these reports is that they non-actionable data. Scores in existing performance management software generally include a subjective component that limits the ability of the worker under review to quantitatively understand what she should do differently in order to increase her ‘performance score’. In addition, most performance management scoring in organizations today are used more to manage compensation than performance and so ‘performance scores’ are less relevant to how one worker actually performed against others in a cohort and more relevant to how the organization prefers to structure its compensation curve.

Reputation assessment is a way of evaluating a person's trust and influence by getting feedback from the people that person supposedly interacts with. This reputation information may be used by employers in work assignment and promotion decisions, and by the worker in a job search. Current reputation techniques suffer from four main problems:
Accuracy—they may not reflect the true past or likely future worker performance.
Applicability—they may not relate to relevant skills, knowledge, or talents.
Availability—they may not be readily accessible to either the employee or the person who wishes to review their reputation.
Authenticity—they may be subject to manipulation by an individual who wishes to enhance their reputation or by a person who wishes to malign a worker's reputation.

Current reputation assessment techniques include: Letters of reference, and verbal reference checks, Professional licenses and certifications for some professions. More recently, scores or skill badges in online professional networks and online question and answer forums.

Letters of reference and verbal references suffer from all four problems, as the person providing the reference may not be fully aware of the employees past performance and the applicability of the performance to the requirements of a new prospective role. The feedback is also typically colored by a social relationship between the employee and the person who has agreed to act as a reference for them. Reference checks are time consuming for both the reference and the individual evaluating the reference. Finally a dishonest individual can arrange for a fraudulent reference to be provided.

Professional licenses and certifications provide decent evidence of competency within a small range of truly regulated professions, but are not widely available across careers.

Skill badges and scores from online professional networks have two forms:
Social Endorsements—where the skill badge or score is awarded by an identifiable person within the social network of the recipient. Such endorsements suffer from the same problems as traditional letters of reference.
Anonymous feedback provided by question askers to question answerers, such as in sites like Stack Overflow—This type of feedback is still capable of being manipulated (authenticity) since there is no restriction on who provides the feedback. In addition, the skills assessed through these networks may not be relevant or complete for the skills relevant to a project or position. Finally, today, the results of these network-based assessments are stuck within the particular online network in question.

There is a need for a more effective performance management system that delivers timelier, accurate, relevant and actionable performance metrics that workforce participants can use to guide them towards better career outcomes.

### SUMMARY

The present invention describes a system and method for performance assessment using performance analytics metrics system (PAM). PAM uses varied methods, processes and systems to collect, capture, classify, store, and manage performance data, and dynamically analyze, process and report personalized metrics using such data. PAM provides visibility and transparency about performance management to individual using PAM and to groups such as workforce participants and may be used by individuals and groups to guide them towards better performance outcomes. Embodiments of the present invention are described below, and other extensions are possible without departing from the spirit and scope of the present invention.

In one embodiment, a person, a peer or a mentor, coach, a supervisor, or a performance manager use PAM to input, gather, process and assess a person personalized metrics. The system and method enable the person to set a specific benchmark or goal for a person to achieve his or her personalized performance objectives. In one embodiment, the system and method provides personalized metrics for a person, wherein personalized metrics may include, but are not limited to, how they spend their time, who they spend their time with, how effective their interactions are, how their performance relates to career outcomes, and how their personal performance metrics compare against their peers, colleagues, role models, or other industry, community or organizational groups.

In one embodiment, a continuous assessment of a person's performance metric is done using PAM and displayed on a hardware device in real time. As a method, in another embodiment, once a person is involved in a specific activity the system detects it as a step. In one embodiment, the PAM analyzes and categorizes a person's interactions from various inputs collected by the PAM application, and automatically generates a display to the person showing how the person's time has been allocated over some duration and how that time allocation compares with other peers or persons. In another embodiment, the PAM uses the analysis from a person's interactions to generate performance data, or feedback responses, specific to that interaction showing how the person performs in certain circumstances and how that performance compares with other peers or persons. The PAM can automatically categorize the interaction of the person in the specific activity by collecting data obtained from the person's personal productivity accounts, such as description of the activity, location of the activity, format of the activity, attendance at the activity, duration of the activity, who scheduled the activity, recurrence of the activity, who is attending the activity, and the relationship of the attendees. PAM provides a method for obtaining optimized performance feedback.

In one embodiment, PAM detects that a person has had an interaction as a result of analyzing various inputs collected by the PAM application, and triggers a feedback request relevant for that activity type to be automatically presented to others involved in the interaction. The involvement of a person can be authenticated by collecting inputs from various personal productivity accounts of the person, such as calendar accounts and messaging accounts, or from information collected by the person's personal computing devices. This allows obtaining performance feedback using a system.

In one embodiment, PAM associates analysis of feedback received regarding a person with goals set for a person, and automatically generates a display of gaps between a set goal and the person's existing analysis results.

In one embodiment, PAM computes statistically relevant information about the feedback received regarding a person and regarding the quality of the feedback from the feedback provider, and generates a display of that analysis.

In one embodiment, PAM may easily be applied to any interacting group, such as students in a class or school, members cooperating on a social or community project, employees of an organization, people in some common geographic area, or even an online social network with interacting members.

In one embodiment, PAM may be standalone software, enterprise software, socially embedded software, guidance based software or combination of one or more software applications.

In one embodiment, a system comprising of a network, hardware, mobile devices and database to host, run, display and store the PAM is described. In another embodiment, the network may be local area network (LAN), wide area network (WAN), metropolitan area network (MAN), extranet, intranet, internet, or peer-to-peer network.

In one embodiment, a system with unified hardware may host all or parts of the PAM. The system may contain hardware and software related to administration, input, classification of data, analysis, recommendation, display, management, collaboration, server control, network control, management and communication functions, cloud and network management modules within the client firewall and/or on distributed cloud computers (including mobile and e-devices, wearable, and desktop devices, etc.).

In another embodiment, the system measures various inputs such as how people spend their time, who they spend their time with, how effective their interactions are, how their performance relates to career and business outcomes, how they perform against their goals and how they maintain and enhance their personal or business reputation. This system is not just limited to this example but it can be applied to various other fields as well which requires comparing the output to a set goal.

In one aspect, a method comprises enabling a person such as an individual or an organizational representative or a group of people to input data from disparate sources and analyze the data using PAM to output, correlate, compare and quantify the impact of personal actions and interactions, correlated activities and personal performance for a specific time.

In another embodiment, a process to perform a personal career analysis is done using PAM by the person. This supports automatic performance review documentation. This enables the person to specifically target certain areas to be improved and certain areas to be compared with higher achievers or role models. In one embodiment, PAM provides an opportunity for an individual to set goals, self-assess, quantify the impact of their actions, compare and improve for a better life and/or career.

PAM as a system comprises novel modules such as input, classification, analysis, recommendation, display, management and communication. Each module will be discussed in detail in the following paragraphs under detailed description.

In one embodiment, PAM is a tool to help employees and their employers quantify the impact of their day to day activities and interactions and correlate them to actual career results and business outcomes by providing real time visibility into (1) how time is actually spent, (2) the effectiveness of interactions, (3) correlations between activities, performance and career and business outcomes, (4) progress against goals, and (5) individual or business reputations.

In another embodiment, a method of collecting, analyzing, and presenting of the proposed personal and activity data using PAM will enable the person to get answers more effectively in real time and be more successful in their careers.

In one embodiment, real-time feedback is provided by the back end intelligence, where the feedback is obtained while the project is in session. Questions are asked intelligently based on the functions, resources, experience and seniority. In one embodiment, deterministic evaluation is done where the feedback is asked at a specific period of time. In another embodiment, a stochastic feedback is asked at the right time which is analyzed for confidence interval. Real-time feedback enables immediate changes to behavior of the team.

In another embodiment, a non-real-time feedback is taken by the backend intelligence, where the feedback is obtained when the project is over. This allows the persons to think through and answer but is useful only for future project corrections and immediate changes are not possible that can affect the project goals.

PAM handles two types of customers. In one embodiment, internal feedback within the company to employees, group manager, executives, shareholders and cohorts are taken. In another embodiment, PAM allows intelligence in performance analytics across markets enabling comparison among verticals, competency, mentorship, talent management, and cohort performance.

In one embodiment, using PAM a cohort performance profile is constructed from the collected results. A Cohort Performance Profile is a performance profile automatically constructed from the results of the performance metrics collected for that cohort. For example, a cohort might be people in a sales role selling software. A cohort might be a group of people within a company, across companies, across industries, or another combination of people. In one embodiment, a Cohort Performance Profile can be used by a PAM to compare a PAM within that cohort against the cohort in general. In another embodiment, a Cohort High Performance Profile is a specific type of Cohort Performance Profile that may only use performance metrics from people within a cohort that are tagged as being high performers. In yet another embodiment, a Cohort High Performance Profile may be used by a PAM (the individual person themselves, a hiring manager, a supervisor, a performance coach) to evaluate whether an individual is likely to perform at a high level in a particular role by benchmarking the individual's performance profile against that of the relevant Cohort High Performance Profile.

In one embodiment, using PAM an automatic performance review documentation method is created. Performance review documentation is automatically generated by mapping the results of the data collected by the PAM for a person of the PAM with predefined career analysis stored in the Backend Intelligence of the PAM to automatically generate a career analysis personalized for a person of the PAM. The mapping can be accomplished using pre-defined associations or using the Backend Intelligence heuristic engines. In one embodiment, a personalized career analysis may be used by the PAM who it is personalized for. The Personalized career analysis may be used by a manager, supervisor or other career coach (the assessor) of the PAM who it is personalized for. The assessor would use the personalized career analysis to supplement or even replace the standard performance review document often delivered as part of the assessment process. Traditional performance reviews are periodic summaries that combine some elements of goal setting and measurement of accomplishments against goals, along with asynchronous feedback from the supervisor, and perhaps peers and customers. They are typically manually generated, with the supervisor and/or the subject of the review producing written content to summarize their goals and achievements. In one embodiment, the Personal career analysis generated by the PAM differs in these ways: Performance is characterized not just once near the end of the period overall, but on a continual basis throughout the period, showing trends in performance. Performance is not isolated to the behavior of a specific individual, but may be described relative to their peers using Cohort Performance Profiles as comparisons. As an example, if a development project went into “crunch time” and an entire development team was extremely busy trying to remove bugs and prepare a release for an upcoming deadline, all members of that team might expect to see a decrease in scores related to things such as meeting punctuality, promptly following up on emails, or providing mentorship and support for other team members. The PAM can contextualize an individual's performance against those of their team to show whether a decrease in some performance attributes is reflective of an individual performance problems or of a team or systemic issue. The PAM can issue intermediate alerts and/or show an employee or supervisor how the performance evaluation document would look if it were to be produced today—this allows employees and supervisors to manage their efforts and activities towards the desired review content at the end of a review period, eliminating surprises and mismatches in perceived performance and evaluated performance in the review document

In one embodiment, a person's ownership of their reputation is guaranteed within PAM. A person's scores and ratings within PAM for their various performance attributes remain available to the person indefinitely, regardless of their current relationship status and participation within a given organization or group.

In one embodiment, using PAM enables a method for obtaining performance feedback. In another embodiment, PAM includes an effective structure for collecting performance data

In one embodiment, PAM enables a method to create relationship profile and career trajectory over time. By combining aggregate data across many persons, PAM identifies the typical career trajectory and the competencies, skills, and timelines adherent to obtaining career objectives.

Intelligent backend system provides automatic performance review documentation, time management dockets, correlation based feedback, effective feedback collection, causal career relationships and commitment analysis. In one embodiment, back end intelligence provides forensic analysis capabilities to check historical data to analyze the trends.

In another embodiment, back end expert system allows the data to be analyzed for better refinement of heuristics and training purposes. The system also allows investigation and fine tuning of product.

The systems and methods disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF DRAWINGS

The embodiments of this invention are illustrated by way of example and not limitation in the figures of the accompanying drawings, in which like references indicate similar elements and in which:

FIG. 1 is a block diagram of an example of a PAM 100, according to one or more embodiments.

FIG. 2 is a block diagram illustrating the different modules within a PAM application 200.

FIG. 3 illustrates the performance metric impacts within the organization.

FIG. 4 provides insights into various feedback types and the time dependencies.

FIG. 5 illustrates intelligent performance analytics metrics solution that pervades various levels within an organization.

FIG. 6 illustrates the intelligent performance analytics metrics components of backend system.

FIG. 7 shows the client side components for the intelligent performance analytics metrics system.

FIG. 8 illustrates the intelligent performance analytics metrics system server components.

FIG. 9 shows the architecture and dependencies of the system.

FIG. 10 illustrates the control and the data flow for performance analysis metrics system.

FIG. 11 shows the high level message sequence diagram illustrating a person using the system.

FIG. 12 illustrates one example display generated by a PAM application 200 allowing a person to view, add, drop or edit performance goals.

FIG. 13 shows an embodiment of example inputs into a PAM application, and example outputs from the PAM application.

FIG. 14 shows an example of how different activity types may be categorized by a PAM.

FIG. 15 shows an embodiment of example feedback inputs into a PAM application, and example performance outputs from the PAM application.

FIG. 16 is an example block diagram of a person flow of PAM 100.

FIG. 17 is an example of a person's activity map generated by PAM 200 displayed in a spider web format.

FIG. 18 is an example of a comparative display generated by a PAM of a person's activity map against a calculated activity map of a particular cohort.

FIG. 19 is an example display generated by a PAM for a person so that the person may drill down into his own activity map and request a breakdown of the categories of activities or interactions over a specified time period.

FIG. 20 shows an example display of how PAM may generate a performance profile of a particular cohort using the results of the performance metrics collected for that cohort. FIG. 20 also shows an example display of how PAM may generate targets, perhaps using them to recommend goals, based on the results of comparisons of the person's performance metrics against a particular cohort's metrics.

FIG. 21 shows an example flow of an employer flow of PAM 100.

FIG. 22 illustrates an example on how PAM may display each person's aggregated feedback from everyone they interact with.

FIG. 23 illustrates a performance manager's ability to easily monitor the strengths and weaknesses of his or her team.

FIG. 24 illustrates how a PAM display provides an organization with visibility to the performance health of the workforce.

FIG. 25 illustrates the graphical mode of plotting performance of the entire organization.

FIG. 26 illustrates how a PAM might display the case of one team's assessment of another team's impact using performance histograms generated from the performance metrics analyzed by PAM.

FIG. 27 illustrates the performance graphs for an individual to compare their individual roles to that of company and industry at large.

FIG. 28 illustrates an embodiment of how PAM intelligently determines appropriate feedback requests in real-time during or immediately following an interaction.

FIG. 29 shows the intelligent system backend of PAM obtaining feedbacks and ratings from every participant.

FIG. 30 illustrates an embodiment where the feedback graph is simplified for one participant in the interaction, Maggie.

Other features of the present embodiments will be apparent from the detailed description that follows.

### DETAILED DESCRIPTION

It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

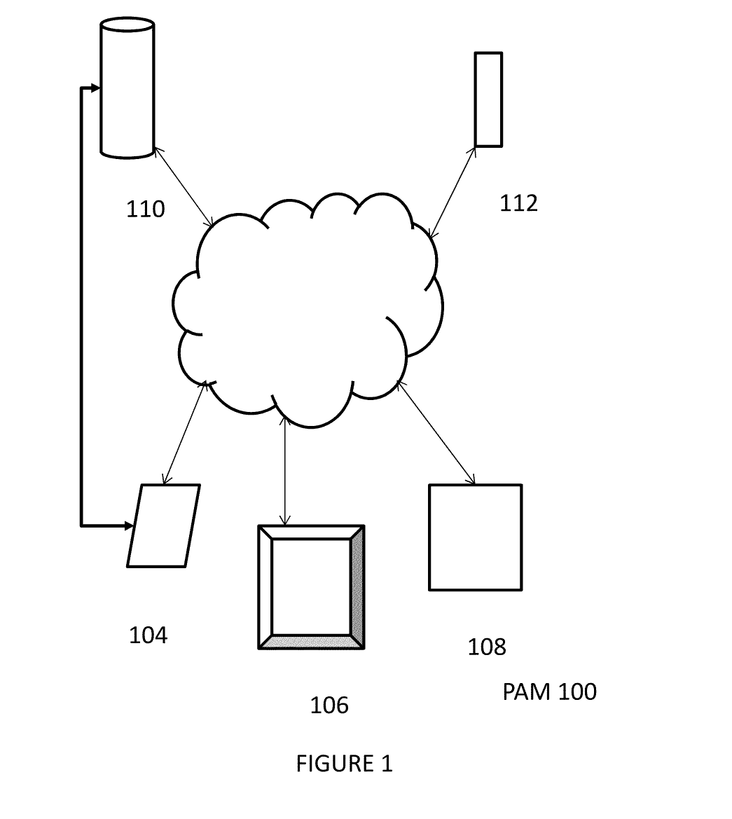

FIG. 1 is a block diagram of an example of a PAM 100, according to one or more embodiments. Particularly, the PAM is supported by server 104, computing devices 106, 104, 108, and 112 (some, such as device 112, which may be mobile devices), a network 102, a database 110. A network 102 may be a local area network (LAN), wide area network (WAN), metropolitan area network (MAN), extranet, intranet, internet, peer-to-peer network or the like or a combination thereof. In the case of a wireless network, 102 may comprise, but need not be limited to HomeRF, HiperLAN, Bluetooth, Zigbee, WiMAX, Wibree, FM, AM, 802.11 (G, N), WiFi and satellite, Wireless ISP, Satellite Broadband, Mobile Broadband, Local Multipoint Distribution Service and satellite communication systems etc. In one embodiment, the PAM may be a server-client system with processing occurring on one or more computers or mobile devices connected through a network 102. In another embodiment, the PAM may be a peer-to-peer system with processing occurring in all computers or mobile devices connected through a network 102. In one embodiment, data is aggregated and stored in a central database server 110 connected to one or more computers or servers either directly or through a network 102. In another embodiment, data stores may be distributed among various devices and servers in the PAM.

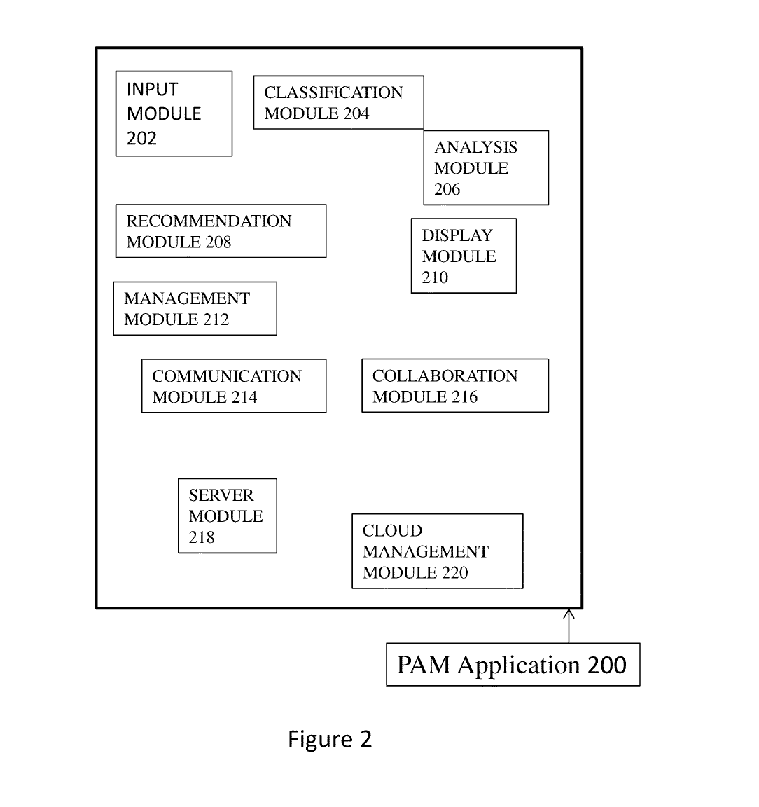

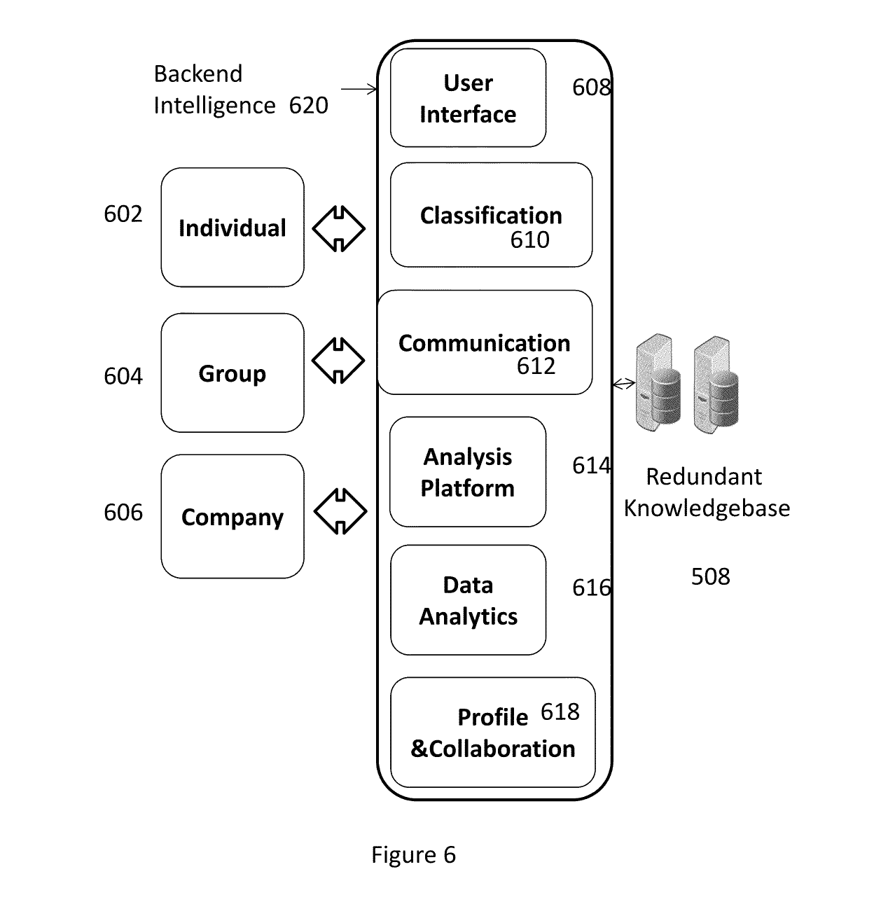

FIG. 2 is a block diagram illustrating the different modules within a PAM application 200 where the person input is taken. Modules in FIG. 2 have interfaces to the persons, and one-to-one connectivity to the back end intelligence. The modules in back-end intelligence that provide active support and computation work based on stimuli from the blocks in FIG. 2. For example, the person interface for input module 202 receives person input and relays to back-end intelligence person interface 608. Similarly, classification module in 204 interfaces with back-end classification module 610. Further information of back-end intelligence is provided in FIG. 6.

In FIG. 2, Input Module 202 may receive inputs from other systems within or external to the PAM, and from persons. Classification Module 204 may contain system templates and may request data from other modules within the PAM application to create associations among data using system templates. Classification module 204 may also generating descriptive text for each performance metrics data. In this system the descriptive text is generated using either pre-defined associations of text to performance attributes or using heuristic engines. The performance metrics data generated from the processing of responses includes a comparison of data generated for the person against data collected for a cohort of people, and wherein the performance metrics data presented is displayed in comparison to aggregate performance metrics data for the cohort of people.

Analysis Module 206 may receive data from other modules and process that data to generate individual or aggregated performance metrics and compile the set of descriptive text. Recommendation Module 208 may calculate recommended performance goals or activities based on results of classification and analysis. Display Module 210 may present a person interface to a person to visually display results generated by the PAM application. The display person interface may be interactive allowing the person to view, add, edit, configure, copy, store, remove, send or comment upon displayed results. In one embodiment, automatic performance review documentation uses these methods. Presenting of the compiled set of descriptive text in a predefined format in an interactive display for the person who queries the system.

One of more Input Modules 202 may receive data through integrations with other systems or through manual inputs. The Input Module may automatically pull content and associated meta data from multiple sources, including but not limited to, a person's contacts, calendar, email, phone logs and other individual accounts. This data may be used by the system to analyze how, with whom and for what general purpose the person is spending his time.

As another example, the system can receive information from enterprise systems such as enterprise CRM databases or corporate directories, or from the person's social network or social media accounts, or contextual information from the person's device such as GPS data, thereby increasing the contextual understanding of a person's interactions and increasing the accuracy of identifying the correct activity type. These sources of information also provide the system with data about the person that can be used to complete the person's profile for the purpose of connecting the person to different person cohorts for benchmarking purposes.

The system can also seek manual input from the person or others related to the person. The person can provide manual input categorizing a calendar event into a particular activity type, and can add new activity types into the system or change existing activity types in the system. The person can also provide manual input to add to his profile. The person can provide manual input rating the person's own performance (self-evaluation feedback) upon the completion of an activity. The person can provide manual input rating the performance of another PAM (feedback) who the person has had an interaction with or who participated in an activity in which the person also participated. The person can provide manual input setting performance goals for himself/herself. The person can provide manual input setting performance goals for others he works with or interacts with. The system can use data collected from accounts as described above to limit prompts to set goals for only those the person manages. The person can provide manual input indicating achievement of goals or other Personal or business objectives for himself or for others he works with or interacts with. The system can use data collected from accounts as described above to limit prompts to input achievements to only those people who the person manages. FIG. 2 illustrates one example display generated by the PAM application 200 allowing a person to view, add, drop or edit performance goals.

Feedback solicited from the person can provide information rating the person's own performance during the activity or the performance of others involved in the activity. To mitigate asynchronous reflection, the system may solicit the feedback automatically immediately upon completion of the activity as indicated by the data collected from the Input Modules. To mitigate evaluation inertia, the system may present the feedback request in a visual format that asks the person to click, tap, drag, swipe or perform some other touch gesture on the device screen to indicate a rating, rather than have to key in text or select checkboxes or options. Speed and ease of entry of feedback input are of paramount importance to overcoming evaluation inertia. As a result, specific person interfaces are designed to minimize time and effort required by the feedback provider (the assessor) to provide the feedback. For example a single multi-dimensional input area allows the person to provide a ranking on multiple categories simultaneously, rather than selecting the appropriate value for each category as is common with multiple choice inputs. The module is highly optimized to render as quickly as possible, record input and render the next screen as quickly as possible, and may contains intelligence for ensuring that the feedback is properly recorded and stored in the system. Input may be stored locally on the device, and may also be automatically synced to system servers when an Internet connection is available.

The system may also mitigate evaluation inertia by ensuring that feedback provided on another person is made anonymous (which may be referred to as ‘unsigned feedback’). Such anonymous or unsigned feedback may be aggregated by the PAM over a minimum group size to make it difficult to deconstruct an individual person's feedback. The feedback templates may request ratings on various attributes relevant to successful performance associated with either the activity in question or the person profile in question. As an example, for a training session, the feedback template might ask students for ratings on the trainer's clarity of communication; for a sales PAM, the feedback template might ask customers for ratings on their willingness to act as a reference for other customers on behalf of the sales PAM. Help icons can clarify the meaning of each attribute presented for feedback. The system can capture the (x, y) coordinates of each touch on the device screen and determine the rating score based on those coordinates.

One or more Classification Modules 204 may take in data from Input Modules and (i) use system templates of activity types to categorize each activity in which the person is determined to have participated, (ii) use system templates of cohort types to connect the person's profile to applicable cohorts, (iii) use system templates of feedback types to connect each activity to a particular set of feedback requests, and (iv) classify other data obtained through the PAM according to system templates.

Data collected through the Input Modules can be used to build out each person's profile and classify a person into system templates for Cohorts. The system can include a pre-defined record of cohorts, and can also allow for additional cohorts to be added by the person, or an administrator of the system, or existing activity types to be changed. A person profile may relate to a number of different cohorts—a one to many relationships.

As an example, from calendar data, the Classification Module 204 may calculate how much time the person spends in meetings versus working alone. Using various information processing techniques, such as natural language processing methods, the system may assign a likelihood that each specific calendar activity falls into a more general activity type. Activity types might include, without limitation: travel time, 1-on-1 meetings, group meetings, presentations, training, social event, customer meeting, support call, individual working session or conference. From this analysis, the system can generate an activity map for the person showing the person how he spends his time among these different kinds of activity types.

The Classification Module 204 may match calendar events to activity types using various methods, including but not limited to:

a) Matching the subject of a calendar event to an activity type—for example, if the subject includes the word “meeting” then the event falls within a meeting activity type

b) Matching the number of people invited to an even to an activity type—for example, if all the people invited to the event belong to a particular team within an organization, then the event falls within a team meeting activity type

c) Matching external invitees to active business engagements—for example email addresses from external domains are cross-referenced against a CRM system (i.e. Salesforce.com or other) and the event is classified as a customer interaction

d) Matching the format of a meeting to an activity type—for example, if the meeting has a phone number in the location field, then the event falls within the phone call activity type

e) Using natural language processing methods to evaluate the likelihood that the language used to describe the calendar event (either within the calendar event record or in other records such as email) relates to a particular activity type.

One calendar event may relate to a number of different activity types (a one to much relationship). The system may use hierarchical relationships to better understand the context of a calendar event based on the multiple activity types to which it relates. The system may also assign a probability to each relation between a calendar event and an activity type and use the probability information along with other system data to assess the most likely classifications for that calendar event.

As another example, adding information from contacts and email accounts, the Classification Module 204 can learn more about the nature of the activities. For example, an email sent to the same people on a calendar event with the same title might include more details about the activity type for that calendar event. Email addresses can indicate whether meetings are internal to an organization or not. Contact information can assist in identifying whether meetings are with management, customers, or even other family members.

Data collected through the Input Modules can be used to build out each person's profile and classify a person into system templates for Cohorts. The system can include a pre-defined record of cohorts, and can also allow for additional cohorts to be added by the person, or an administrator of the system, or existing activity types to be changed. A person profile may relate to a number of different cohorts (a one to many relationships).

For example, from data collected through the Input Modules, the system may build a profile of a person as a Finance Director working in a technology company with between 100-500 employees having 10 years of work experience with an annual salary of $70,000. Pre-defined cohorts may be based on title (Director), professions (Finance), industry (technology), company size (100-500 employees), years of experience (10), and/or salary ($70,000).

In one embodiment, PAM supports obtaining performance feedback. The Classification Module 204 may map activity types to system templates (using server module 218) for feedback types, creating an association between any activity and the appropriate form of feedback request to be delivered for that activity. The Classification Module 204 may map each goal received from Input Module 202 to appropriate system templates. As an example, a goal of “20 Monthly Customer Meetings—In PAM” may be mapped by the Classification Module 204 to one or more activity types. As another example, a goal of “Promotion within 12 months” may be mapped by the Classification Module 204 to one or more cohorts. As a final example, a goal of “4 or more on referenceability” may be mapped by the Classification Module 204 to one or more feedback templates.

The Classification Module 204 may also allow for additional system templates to be added by the person, or an administrator of the system, or existing templates to be changed. One or more Analysis Modules 206 may create various associations and perform various analyses of activities, person profile, and feedback and goals. The communication module 216 may also facilitate this interaction between persons.

Certain templates may be displayed by the recommendation module 208 for initiating activity when a person login to the system. The person may have a choice to choose the template or create their own template for goals. Management module 212 will keep a log of the choices and save it as a default setting. Enterprise system or the individual system may be stored and used from cloud based servers or systems using the cloud management module 220.

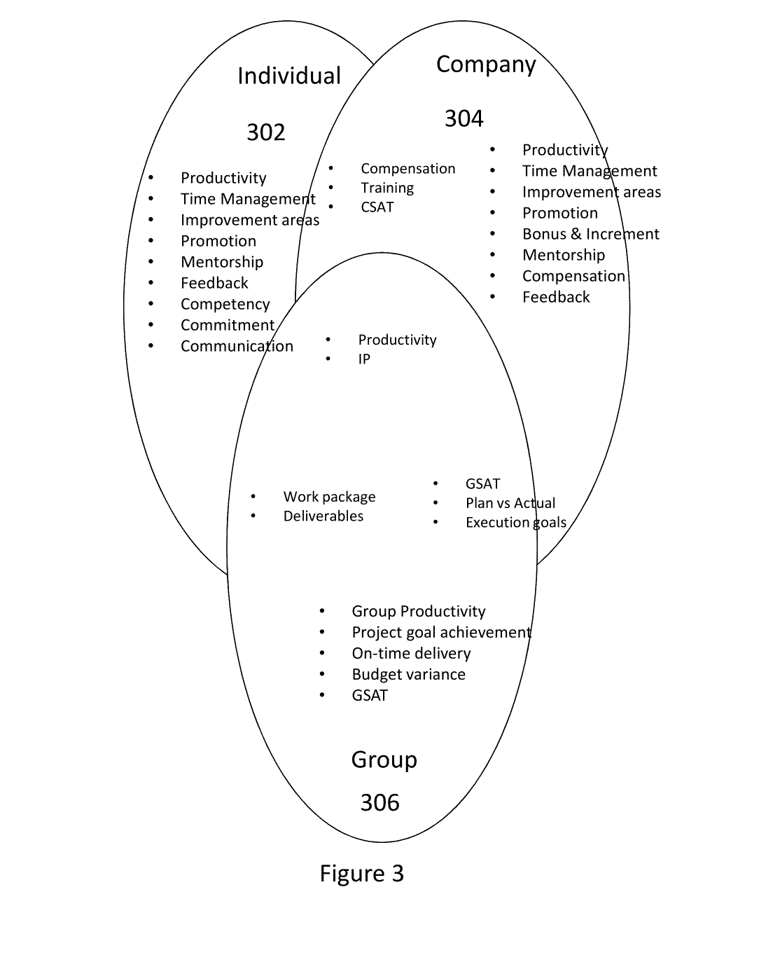

FIG. 3 shows the high level performance metric impacts for a person as an individual 302, team or group 306 and company 304 at large. The proposed Performance Analysis Solution (PAM) operates on the individual 302 performance tracking metrics such as productivity and time management. Through feedback, it also identifies areas to improve such as competency. It assigns proper mentorship and uses the tool as a yardstick for evaluating promotion, competency, commitment and communication.

FIG. 3 also shows the performance analysis at the group 306 level, where the group metrics to measure productivity, goal status, delivery statistics, budget variance and Group Satisfaction (GSAT). The productivity measurements affect individuals 302 as their deliverable constitutes group productivity. Hence tracking deliverable and work package status at individual level, holistically leads to group statistics.

FIG. 3 also illustrates the company level performance analysis, where metrics such as productivity and time management are useful for improving performance of individuals, groups or entire organizations. In addition, metrics compared to other companies can provide improvement areas such as compensation, bonus, increment, mentorships and potential promotions at C-Level. The company level feedback clearly points towards differentiation of areas of concern. For example, group satisfaction taken at various group levels leads to Company satisfaction. Similarly Group level execution goals lead to company level aggregated achievements. Calculation of variation between Plan and Actual at individual group level leads to Company level statistics on delivery on time. Similarly, individual compensation feedback helps understand company's position in the market place. Individual CSAT allows the solution to gauge company resource pulse, and leads to targeted training goals. FIG. 3 shows that the performance feedback at all three levels can lead to enhanced productivity and intellectual property.

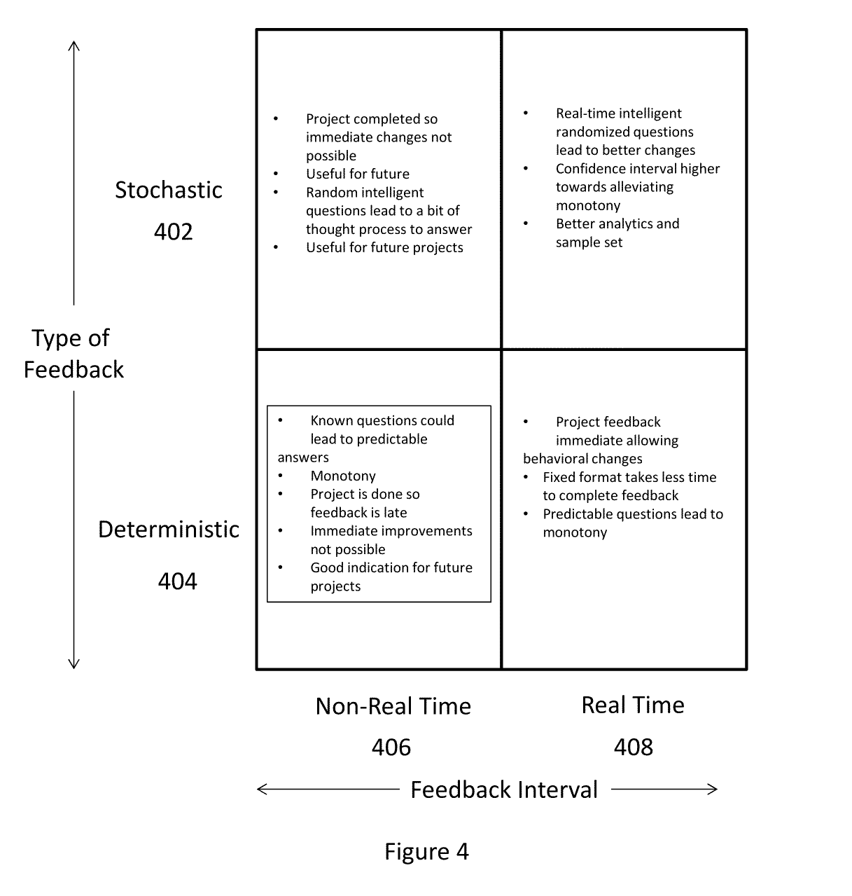

FIG. 4 illustrates an embodiment where feedback is taken real time in a deterministic and stochastic random fashion. First a step is taken to generate one or more of a feedback questions based on the categorization. An automated request is sent to respond to the generated feedback question to one or more persons who were involved in the specific activity; a feedback is received for a response to a feedback request, finally processing of the response after the feedback request is received with other responses received over a period of time and feedback is taken non-real-time in a deterministic and random fashion, when the project is completed.

FIG. 4 illustrates the different feedback types and the impact it has depending on when it is taken. Feedbacks are of two types, Deterministic 404 and Stochastic 402. Deterministic 404 feedbacks are taken at a predictable time using a known mechanism, such as online questionnaire. Stochastic feedback 402 is taken at random times during the course of the project or after completion. The feedback interval could be Non-real-time 406 or real time 408. In Non-real-time feedback 406, the feedback is taken after the project is completed. In real time feedback 408, the feedback is taken during the execution of the project.

FIG. 4 illustrates four quadrants each depicting Deterministic, Stochastic feedbacks taken either non-real-time or real time. Deterministic feedback 404 taken non-real time 406, when the project has completed contains known question leading to predictable answers. The feedback is useful for future projects as it is too late for any corrective actions on present project. Not much intelligence is attached to it. Deterministic feedback 404 taken during real time 408 while the project is on-going allows behavioral changes but could lead to predictable feedback as it is deterministic questions. Non-real-time 406 stochastic feedback 402 leads to some level of intelligence as targeted questions to individuals based on competency and involvement level leads to insights on managing future projects better. Real time 408 stochastic 402 feedbacks require intelligence to pose questions while the project is on-going leading to meaningful changes while the project is progressing. With combination of questions that are not same, but tailored and targeted leads to higher confidence levels towards proper answers and participation. This leads to better set of analytics for real improvement. PAM provides intelligence engine in the back end to pose proper intelligent feedback questions, and analytics engine to analyze it.

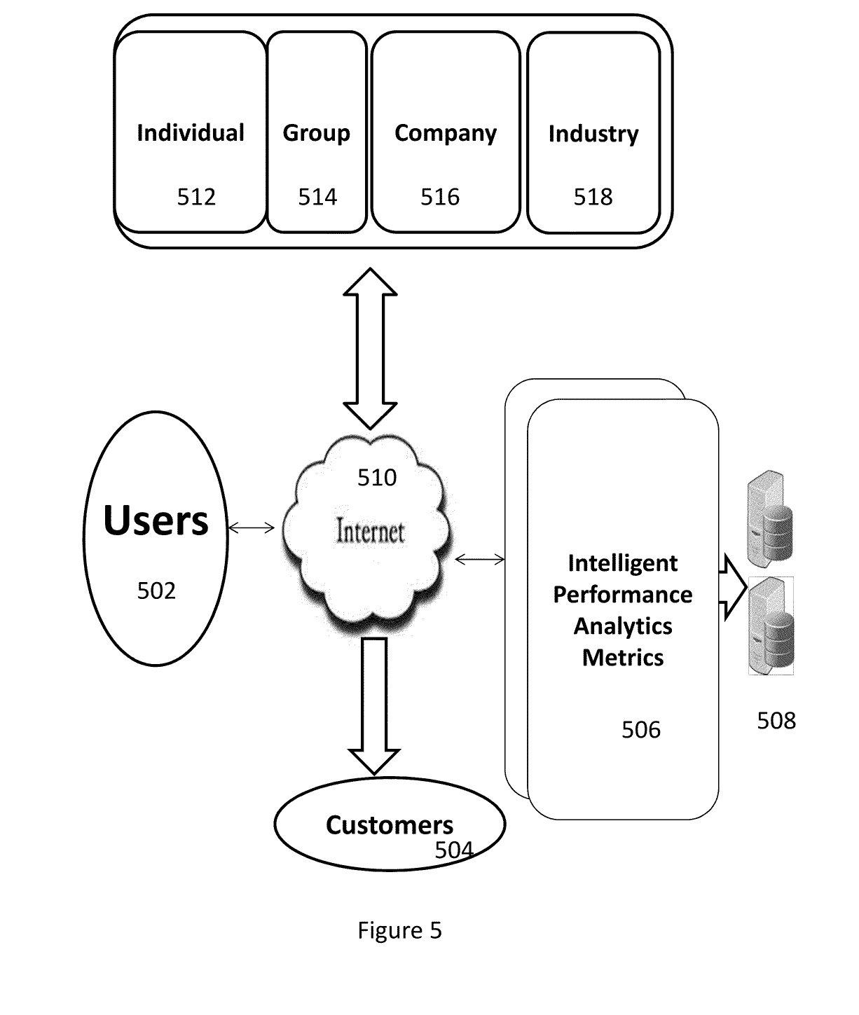

In one embodiment, FIG. 5 illustrates persons to communicate over network to complete and obtain feedback and their respective results. In another embodiment, persons can be individuals, groups, or entire company.

FIG. 5 illustrates the high level intelligent performance analysis solution architecture. The PAM front end of the system has interfaces for individuals 512, group 514, company 516 and industry 518. Persons/users 502, use their devices to access the front end, over the network 510 to provide and receive feedback. PAM Intelligent performance analytics metrics module 506 resides in the cloud connected to the knowledgebase 508. PAM provides services to external customers 504 who require targeted assistance on analytics, in which case they interface with the intelligent backend system 506.

FIG. 6 illustrates the intelligent performance analytics 506 components. The back end intelligence 620 has modules directly interfacing the persons who are individuals, groups and company through modules individuals 602, group 604 and company 606 respectively. The backend intelligence contains the six main modules namely backend person/user interface 608, backend classification 610, backend communication 612, backend analysis platform 614, backend data analytics 616 and backend profile and collaboration 618. The back end intelligence is connected to a redundant knowledgebase 508. The performance metrics data generated from the processing of responses is combined with other performance metrics data generated for that person over time to generate a reputation profile for that person.

The backend person interface module 608 interfaces with the person 602 through the interfaces individual 602, group 604 and company 606. For example, a person providing an individual feedback 502, over network 510, communicates over the front end module Individual 512, which uses Input module 202 to interface and collect data. The data is relayed over the Internet 510 to a cloud based intelligent system 506 through modules Individual 602, and person interface 608.

The cloud based intelligent system communication is managed from the front end through communication module 214 and cloud management 230. Similarly, classification module 204 interfaces with back end classification 610 intelligence module for analytics. Communication of the backend intelligence 620 to the front end individual 512, group 514, company 516 or industry 518 is managed through backend communication module 612.

Backend analysis platform 614 residing in the backend intelligence 620 provides the crux of the intelligence algorithms to analyze the data using heuristics. The data is managed over redundant knowledgebase 508. Similarly, the backend data analytics 616 module provides the important function of translating the analysis into metrics and analytics in presentable form. It also provides the query mechanism that allows customers to utilize the results in the format of their choice. Finally backend profile and collaboration module 618 provides the function of authentication and profile management for customers that are maintained in secure redundant databases.

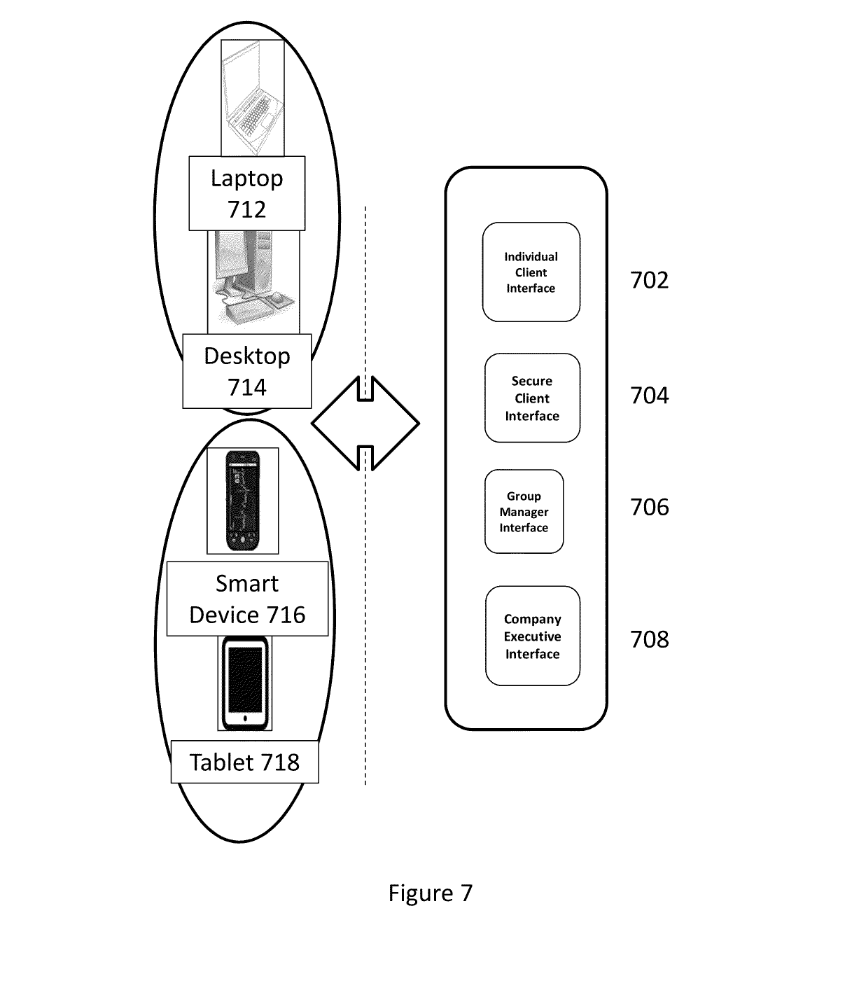

FIG. 7 illustrates the front end client component interfaces for the persons. The persons could be logged in as an individual account 602, group account 604, company account 606 or an external customer 504 account. The persons can login through their devices such as laptop 712, desktop 714, smart devices 716 and tablet 718. The client interface in their respective devices consist of individual person interface 702, security client interface 704, group manager interface 706 and company executive interface 708. The persons use their respective interfaces to login to the performance analysis solution system. The client interfaces communicate with their respective counterparts in front end server over network 510 as shown in FIG. 5, which in turn uses the modules shown in FIG. 2 to communicate with persons, and the back end intelligent system 506.

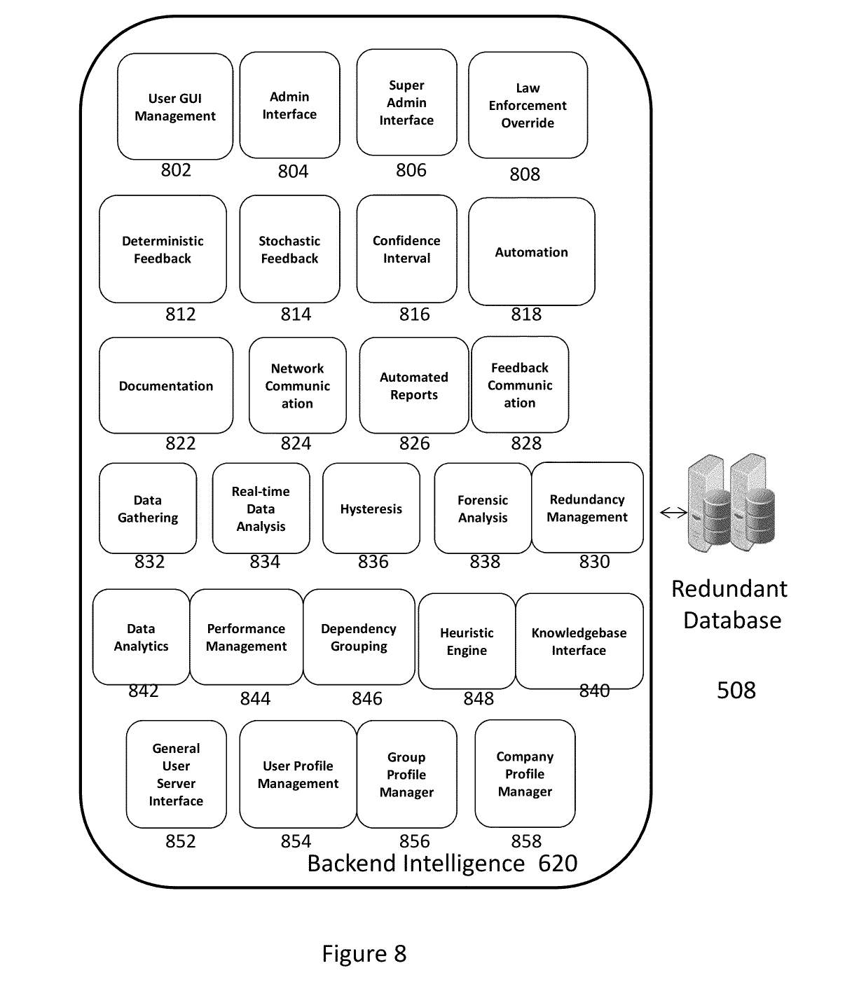

FIG. 8 illustrates intelligent performance analytics system server components which provide the backend intelligence 620. The PAM architecture is modular in nature where every single functionality carries forward from front end interfaces 702-708, to front end interface modules 512-518, to front end server modules 202-220 to back end intelligence 620. The backend intelligence contains backend person interface 608, backend classification 610, backend communication 612, backend analysis platform 614, backend data analytics 616 and backend profile & collaboration 618 functionalities.

Backend person interface function 608 has the following sub function, namely person GUI management 802, admin interface 804; super admin interface 806 and law enforcement override 808. The person GUI management 802 provides the function of controlling the graphic interface for the persons to log into the intelligence system for analysis. The admin interface 804 provides the super person connectivity to the administrator that allows group level functions. The Super Admin interface 806 allows the system level administrator functionality to reboot, reset and maintain the system. It also allows creation of new person, profiles and password reset. The Law enforcement override 808 allows special functionality for forensic analysis in case there is a human resource related litigation or investigation. The person interface module 608 communicates with Input module 202 in the front end to provide connectivity over communication module 214.

Backend classification function 610 provides feedback related functionality. Deterministic feedback 404 for both real time and non-real-time is handled by the Deterministic Feedback sub function 812. Stochastic feedback 402 for both real time and non-real-time is handled stochastic feedback sub function 814. The confidence interval calculations for the feedback accuracy are handled by confidence interval sub function 816. The automation sub function 818 provides the feedback creation automatically when the intelligence modules trigger it.

Backend communication function 612 interfaces with the front end communication module 214 providing persons end to end communication and report sub functionality. The documentation 822 sub functions provide the reports to the person. The network communication 824 sub function handles the network connectivity. Automated reports 826 sub function allows a group manager or a company executive to automatically gather analytics and metrics. Feedback communication sub function 828 handles the result communication of the feedback.

Backend analysis platform 614 functions contain data gathering sub function 832 that interfaces with the person to get the input data. The real time data analysis 834 sub function provides data analysis of the input received real-time. Hysteresis sub function 836 provides the heuristic technique to evaluate the feedback received and categorize the value of it. Forensic analysis 838 sub function provides the capability to analyze the historical data and correlate. Forensic analysis detects that the person has been involved in the specific activity is authenticated by collecting a data from the person's personal productivity accounts or from the person's personal computing device. Categorizing the interaction of the person in the specific activity is automatically performed using the data obtained from the person's personal productivity account or from the person's personal computing device. It provides input to hysteresis 836. The data is retrieved from redundant knowledgebase 508. Redundancy management 830 sub function provides the function to manage the knowledgebase 508.

Backend data analytics 616 functions contain analytics sub function 842 which gathers information and provides analytics, graphs, trends and other important metrics. Performance management 844 sub function calculates the performance of the person, group or company based on metrics. Dependency grouping sub function 846 provides the function to group various persons and functionalities. For example, a sales team within a particular director can be grouped and metrics tracked. Heuristic engine sub function 848 uses hysteresis 836 and real-time analysis 834 to provide intelligence. It correlates with past data, similar persons across market, similar groups across company, similar companies across industry and similar persons across the company. Knowledgebase interface sub function 840 provides the important function of interfacing with the redundant database 508. Redundancy management 830 uses the interface 840 to access the database 508. In addition back end expert system is accessed through the interface. As a method of the system a performance metrics data is generated from the processing of responses using a processor; and the performance metrics data is presented as an interactive display on a hardware having a processor.

One or more of the feedback question is generated in a real time, immediately during or following the completion of an interaction, or after a period of time or a project completion. In another scenario one or more of the feedback question is generated from a database of questions and selected by matching an attribute associated with the question to an attribute associated with the person and the interaction. In yet another embodiment, one or more of the feedback question is generated from a database of questions and selected heuristically.

Backend profile and collaboration function 618 manages the server profiles 852, person profiles 854, group profiles 856 and company profiles 858. Administrator or super administrator uses admin interface 804 and super admin interface 806 to manage the profiles.

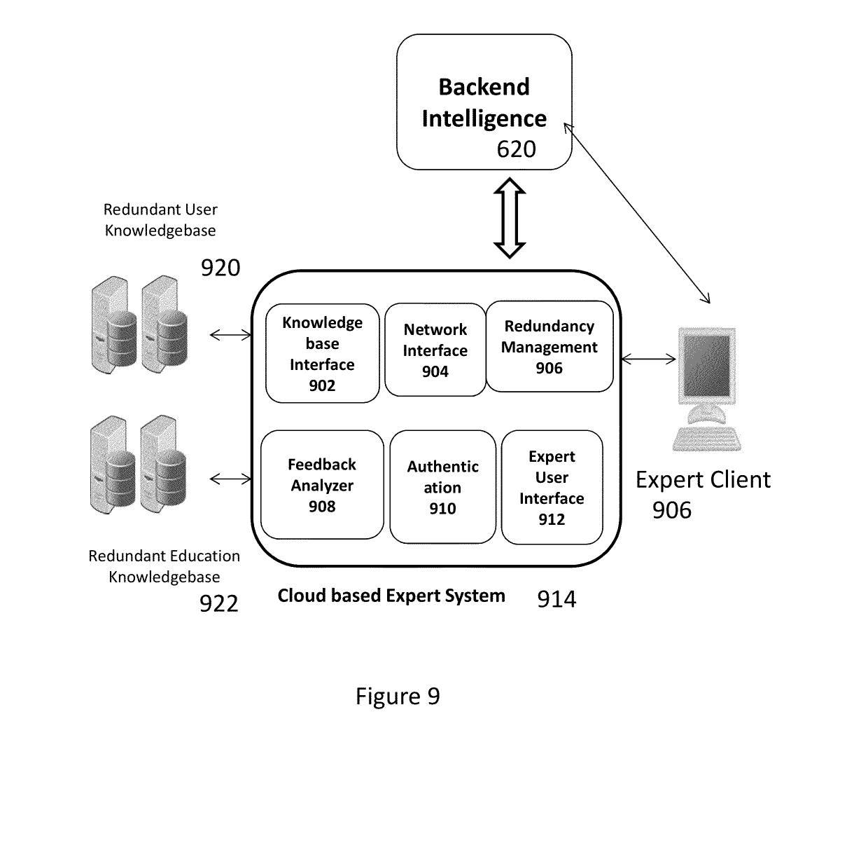

FIG. 9 provides the back end expert system architecture. The back end cloud based expert system 914 interfaces with back end intelligence 620 providing expert system functionality. The feedback taken periodically is saved in person knowledgebase 920. The knowledgebase interface 902 is used to access the historical data 920. Expert client 906 who does analysis of the past and present data communicates with back end intelligence 620 and cloud based expert system 914. The network interface 904 provides the communication management function to the expert system 914. Redundancy management 906 function manages the redundancy of both person and education knowledgebase 920 and 922. Expert client 906 uses the education knowledgebase 922 to educate, analyze and conduct what-if scenarios. Authentication function 910 provides the person authentication of expert client 906. Expert person interface 912 provides the interface through which the expert client 906 logs into the system.

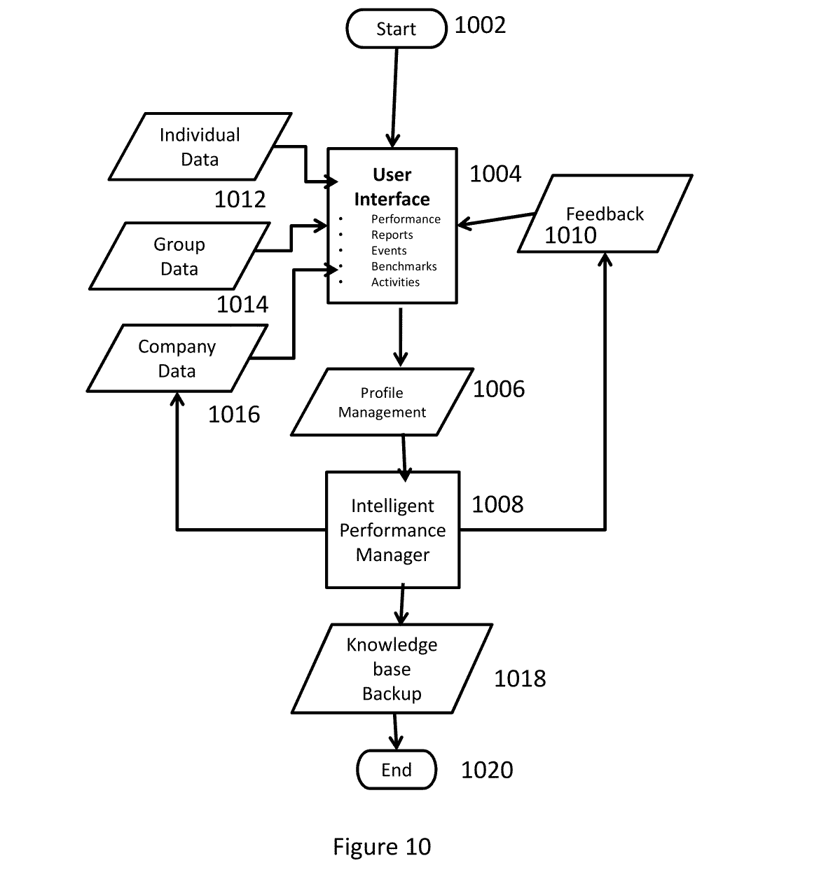

FIG. 10 illustrates the control and data flow of the PAM system at a high level. Individuals who log into the system provide individual feedback 1012, group information data flow through 1014, and company information data through 1016. All data are done through person interface 1004. Person interface 1004 also provides performance information, reports, events, benchmarks and activities. The person interface 1004 authenticates with back end profile management 1006. Intelligent performance manager 1008 in the backend controls the real-time, non-real time, deterministic and stochastic feedback collection 1010 which is displayed through person interface 1004. When the feedback process is complete the knowledgebase 1018 is updated for further analysis.

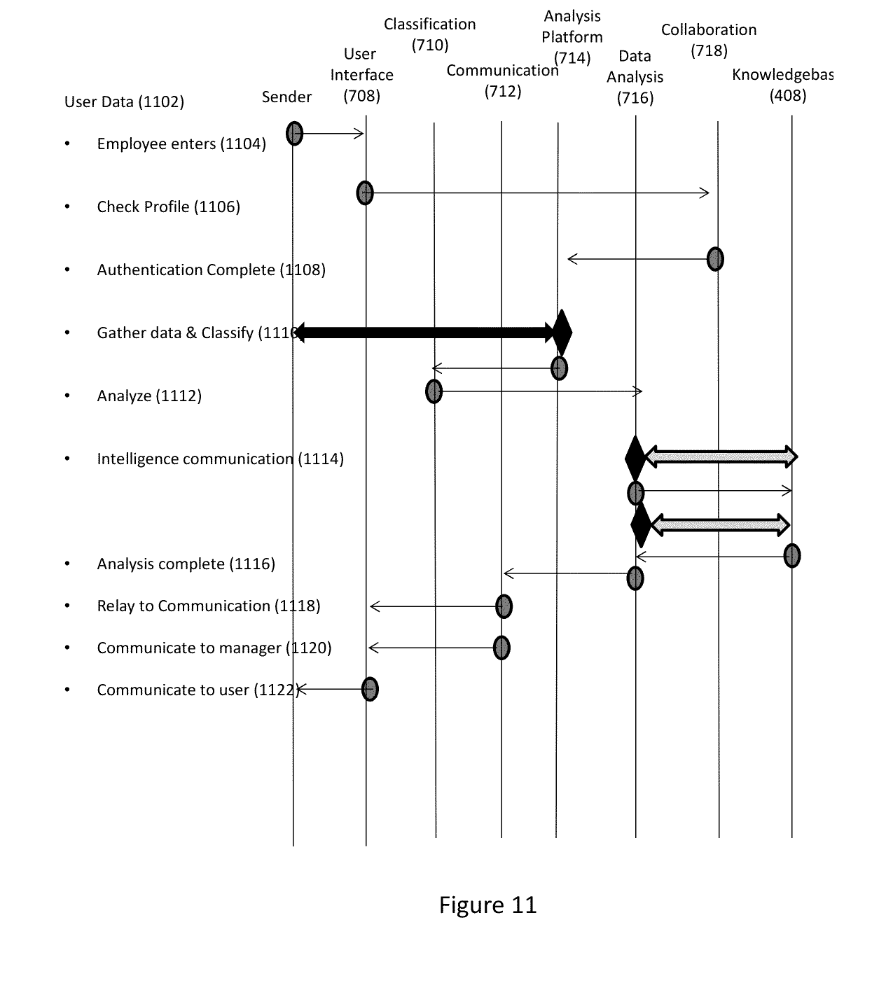

FIG. 11 provides the feedback gathering and analysis message sequence chart. The steps for person data gathering 1102 is clearly enumerated. Person enters the data 1104 which is received by person interface 708 module. The person authentication is completed by checking the profile 1106 through collaboration 718 module. When authentication is complete 1108, the sender is notified and data gathering and classification 1110 is done. The data gathering and classification done through analysis platform 714, is analyzed 1112 in data analysis module 716. The analysis uses knowledgebase 408. The feedback is controlled by back end intelligence 1114 for proper input. The analysis through data analysis 716 of feedback 1116 is completed when the feedback is done. The results are communicated through communication module 710 over person interface 708 to the person 1122.

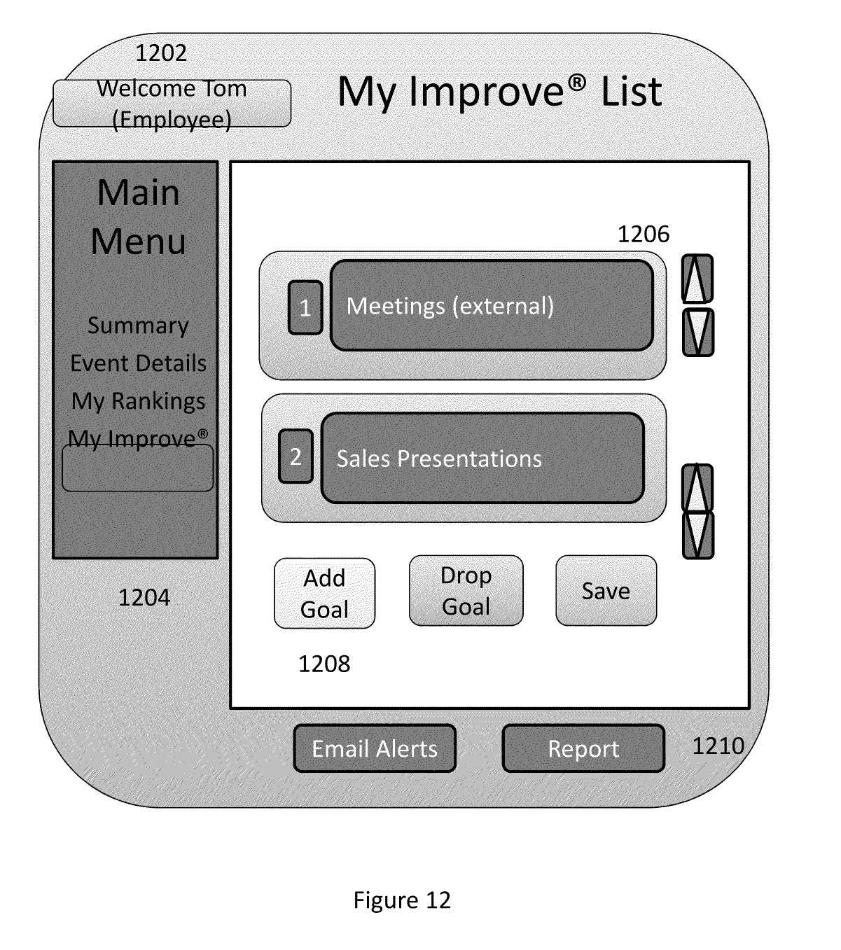

FIG. 12 shows an embodiment of example inputs into the PAM application, and example outputs from the PAM application using data generated by an Analysis Module 206. FIG. 12 shows an example of how different activity types may be generated by the PAM. From the results of the Classification Modules, the Analysis Module 206 may generate an activity map showing the person how he spends his time among different kinds of activity types. From the results of the Classification Modules, the Analysis Module 206 may generate various benchmark dashboards showing where the person's profile stands as compared with others within selected cohorts. As an example, the person can choose to see a benchmark dashboard of how his salary compares with other Finance Directors or how his title compares with others in medium sized technology companies with 10 years of experience. Using other information that can be collected from person profiles, the Analysis Module 206 can show other benchmarks such as the how recently persons from the same cohort that have taken on new roles. After receiving a set of attributes; and generating questions that provide reliable evidence of an attribute for a person; one or more feedback questions are generated by matching the attributes associated with the generated question to the attributes associated with the person and the interaction.

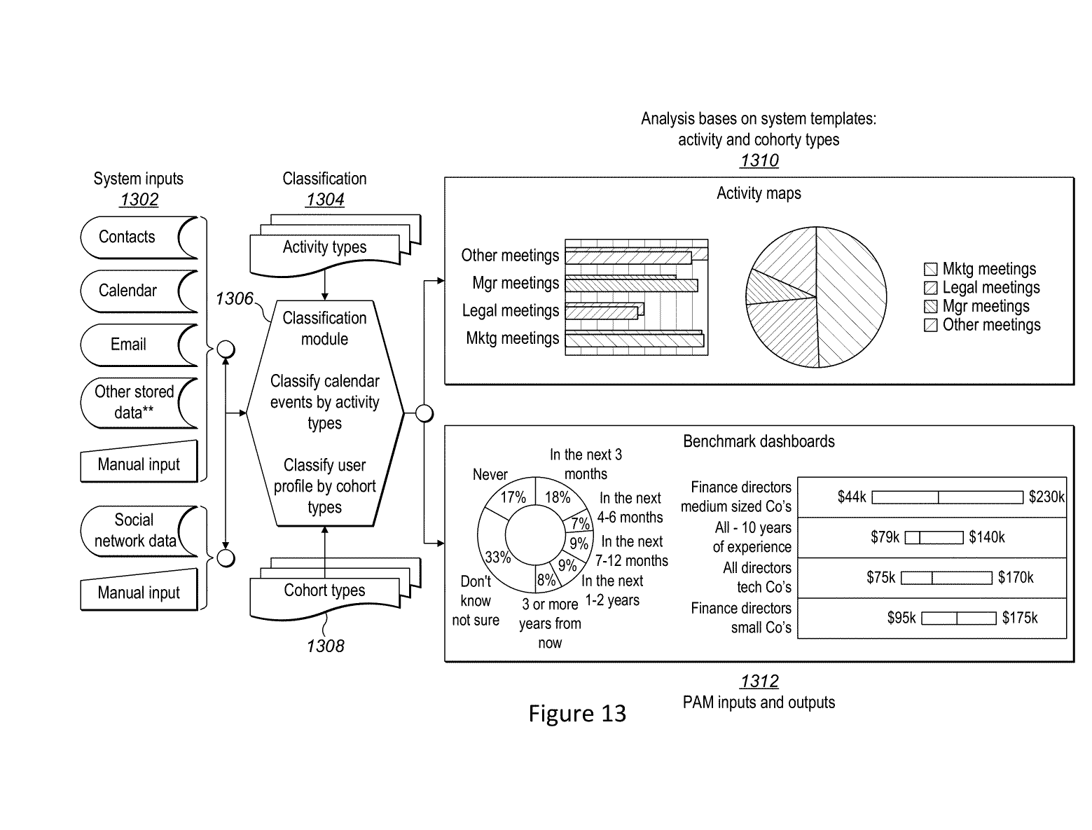

FIG. 13 shows the dashboard of the person (employee) so he can start entering data and set goals for My Improve ^{R} list. This graphical person interface is made to be simple and not intimidating. The different modules described in FIG. 2 provide support as a system and process using seamless architecture. FIG. 13 shows an embodiment of example inputs into the PAM application, and example outputs from the PAM application using data generated by an Analysis module 206. FIG. 13 also shows another example of an output using data generated by an Analysis Module 206. From the results of the Classification Module, the Analysis Module 206 can generate a feedback template for every classified calendar event and prompt the person to provide feedback through the template.

As an example, an Analysis Module 206 may receive data from an Input Module 202 that a person has just completed an interaction such as a meeting, phone call, or other event or activity. The Analysis Module 206 may then request from a Classification Module 204 the feedback type associated with the activity type for that interaction. Upon receiving the feedback type data, the Analysis Module 206 may require a Communication Module 214 to send an automated feedback request notification, based on that feedback type, to workforce participants who participated in the interaction soliciting feedback about the person. Feedback received will flow back to the Analysis Module 206 for various analyses as described below. To mitigate asynchronous reflection and inaccuracy of the feedback, the feedback request may be delivered immediately upon completion of the interaction, so that the details of the interaction are still fresh in the participants' minds. To mitigate evaluation inertia, the feedback request is sent automatically to a participant's device through the communication system, rather than requiring the PAM being evaluated to take any manual steps to request feedback or requiring the evaluator to take any manual steps to initiate a feedback request.

Rating scores from feedback received from Input Modules 202 may be aggregated using robust statistics to assess both the “aptitude” for the attribute (for example determined by the median score), and the “consistency” of the attribute (for example determined by the interquartile range). From the results of the feedback, the system can generate various performance dashboards showing how the person performs according to all activities, or different kinds of activities, or according to different kinds of attributes.

To increase the usefulness of the feedback used in generating the performance dashboards, the Analysis Module 206 may aggregate feedback over a minimum number of feedback providers and anonymize the source of individual feedback. In that way, a provider of feedback is less likely to skew her feedback to the person believing it can be traced back to her. In addition, the Analysis Module 206 can average feedback results, calculate the range of the feedback results, and display other statistical data about the feedback results allowing the person to assess the overall relevance and accuracy.

The Analysis Module 206 may also use feedback results to create an explicit rating or reputation for that person. As an example, if the analysis of a particular person's feedback shows that a particular attribute X has a high consistency score as well as a high aptitude score, the system may translate these scores into an explicit rating that the system, or the person, can post to the person's profile. In this example, the system may have calculated a rating for a person of 7.5 out of a total of 10 for the attribute “inspiring presentations”. This rating could be used in this form in the person's reputation rating, or it can be translated to other another form of rating such as 4 out of 5 stars, or a certain sized bubble representing the quantity of the rating.

Such a reputation ranking system improves upon existing alternatives because it is based on data accumulated from people who have had real interactions with the PAM being ranked that are relevant to the attribute being ranked, reducing the possibility that the raking is manipulated or derived from irrelevant sources. In addition, the anonymity of the feedback increases the likelihood of authenticity of the rankings.

The Analysis Module 206 may mathematically process data to generate averages, minimums, maximums, or other statistical data, trend data, extrapolated data, sorted data, filtered data and the like.

A Recommendation Module 208 may calculate recommended actions for the person based upon Classification and Analysis results supporting the embodiment to provide automatic performance review documentation. Once goals are set and mapped as described above, a Recommendation Module 208 may generate recommendations to a person for closing the gap between a set goal and the person's existing analysis results. A Recommendation Module 208 may generate such recommendations using one or a combination of the following methods:

Person Inputs, where a person having a certain role, such as a manager, coach, or HR representative, can manually input recommendations for the person to follow.

System generated recommendations, where the system stores pre-defined recommended actions to improve specific performance attributes and displays appropriate recommended actions to the person in a display module for an attribute that is currently rated below the goal set for the person for that attribute.

Advertised recommendations, where the system allows suppliers to advertise for goods and services to assist the person in achieving the set goal.

A Display Module 210 may receive data from Analysis and Recommendation Modules and displays them to a person in different formats depending upon the kind of data being displayed and the role of the person.

Role Based Access Controls, commonly used in software applications requiring different displays for different person types, can be used to determine the appropriate data to present to, and formatting for, each person role. Use roles may include Admin, Manager, Individual Person, Assessor, Mentor, Mentee, Teacher, Student, and other custom-configured roles. As an example, a person with a manager role may able to view aggregated display results for the manager's entire group, but may not be able to drill down to see the detailed information for any particular person or any particular activity type.

The Display Module 210 may provide the person the ability to control which individual or which roles are able to access the results from the Analysis Module 206 for that person. The Display Module 210 may allow each person to choose which of the calculated reputation ratings he wants to post to his public person profile, which he chooses to make visible to other persons (such as a manager, coach or assessor) and which he chooses to keep private.

A Display Module 210 may generate an activity map showing how a person spent his time (or a group of persons spent their time) over a range of dates. Because the activity map is automatically generated from the person's existing calendar accounts and other system inputs, results can be viewed by the person in real time without additional generation effort on the person's part. In addition, because the system has activity map results aggregated over many persons of the same cohort type, a Display Module 210 can also display a comparison dashboard showing a particular person's activity map as compared with an aggregated map of a particular cohort type. This kind of display allows a person not only to see how he has been allocating his time, but also how his time allocation compares against the average for a certain type of person profile. This kind of comparison display contains actionable data since a person can use the results in this display to set goals about how to change his time allocation to make his individual activity map match closer to an average activity map for a particular person profile. It may be that a manager or coach benefits from seeing how her entire group or class allocates their collective time over a range of dates. Activity maps among individual persons can be aggregated for viewing by a manager, coach or other person role.

A Display Module 210 may provide the ability for an individual person to “drill down” in any particular display result to view detailed information for any particular event or group of events categorized by the system.

A Display Module 210 may display a person's profile either to the individual person or to another person role. The system may present an aggregated display of person profiles for a group of persons to a manager or coach of that group or other person role.

In addition, because the system has classified person profiles by cohort types using system templates, the Display Module 210 may display how an individual person's profile compares against an aggregate of person profiles related to a particular cohort type.

This kind of comparison display contains actionable data since a person can use the results in this display to set goals about how to change his profile to match closer to an average profile for a particular cohort type. As an example, if a person's profile shows a salary of $50,000 and the target cohort type for that person has an average salary of $100,000, the person can use these display results to set a goal for him in the system to achieve a higher salary in line with that cohort type. The Display Module 210 may display a performance dashboard with results from analysis of a feedback classification module.

In one embodiment, automatic performance review documentation is supported by PAM. Because the performance dashboard is automatically generated from the feedback input for each activity, results can be viewed by the person in real time without additional generation effort on the person's part or on the part of another PAM such as the person's manager or assessor. For example, instead of relying on a manager to write a performance assessment for a particular person at the end of each formal assessment period, these automatically generated performance dashboards can provide more accurate assessments of the person's performance from people who actually interacted with the person and provided their feedback shortly after the interaction occurred, making the feedback timely and therefore likely more accurate.

In addition, because the system has performance results aggregated over many persons of the same cohort type, a Display Module 210 may also display a comparison dashboard showing a particular person's performance dashboard as compared with an aggregated average performance dashboard of a particular cohort type. This kind of display allows a person not only to see how he has been performing, but also how his performance compares against the average for a certain type of person profile. This kind of comparison display contains actionable data since a person can use the results in this display to set goals about how to change his performance to match closer or exceed an average performance for a particular person profile.

In one embodiment, the methodology to achieve the PAM application is the following:

a) Define a cohort—perhaps by title, job function, industry, educational background or other attributes.

b) Aggregate the results of the performance metrics collected from that cohort into a Cohort Performance Profile. The Cohort Performance Profile could be calculated using a simple aggregation of results, an averaging of results, a weighted average of results, or some other mathematical or statistical function.

c) The Cohort Performance Profile may be calculated using only a subset of data, the subset being either a subset of the results from the performance metrics, or a subset of cohorts that are similar in additional attributes. The additional attributes may be that the subset of cohorts are all considered high performers within the cohort as compared with the cohort overall, referred to as a Cohort High Performance Profile.

d) High performers within in the cohort can be identified based on the PAM history of performance, or based upon other inputs into the system, such as, for example, promotion data, salary data or performance data.

e) After constructing a Cohort High Performance Profile, the system may determine which performance attributes are more commonly present in high performers within the cohort as compared with the cohort overall—this defines a set of key performance attributes for this cohort. For example, it may be that 90% of the cohort “salespeople at ABC Company” who are determined to be high performers are consistently rated in the system with a high score the particular attribute of “listening”. The system may then highlight this attribute as indicative of the Cohort High Performance Profile. The system may also indicate the high score that is regularly achieved for this attribute by high performing people in the cohort. The system may further calculate the number of people within the entire cohort “all salespeople at ABC Company” have such high scores for that attribute and display it as a comparison against the high performing cohort in the Cohort High Performance Profile. If the number of people in the entire cohort having a high score in that attribute is only 55%, but the number of people in the high performing cohort having a high score for that attribute is 90%, then through displaying this, the system may reveal to a person of the system that this particular attribute is a critical performance attribute for ABC Company sales people.

f) Benchmark the performance attributes of an individual against the information provided in the Cohort High Performance Profile to determine whether the individual has the requisite performance attributes to perform at a high level.

These benchmarks score could be used in several contexts, such as:

a. Deciding whether to assign a particular employee or job seeker to the job role given their scores relative to the key performance attributes identified for that job role

b. Deciding where to allocate resources on training and professional development to have the greatest impact by focusing on the attributes of performance correlated with the high achievement in the desired job duties

The ability of the PAM system to consider the variety of possible attributes, and to determine which ones are key to achievement in particular role (cohort) is a unique and emergent property of the PAM systems benchmark data, which includes insight from performance analysis not previously available to an individual manager (as they are not privy to performance outside their team) or to an organization (which is not privy to performance data outside their organization).

A Display Module 210 may allow interactive functionality allowing an individual person to change the classification of any interaction to a different activity type or to remove that interaction completely from the display results.

In one embodiment, to create automatic performance review documentation, the person may request performance reports from Display Module 210. The performance reports may be presented as charts, graphs, tables, or other visual presentations based on the kind of performance data being displayed.

As an example, but not limited, for a Personalized career analysis PAM is automatically generated as follows:

a) Associate descriptive text with different combinations of individual performance profiles to provide more contexts around the various aspects of each profile.

b) Associate descriptive text with each performance attribute to provide more context about the skills that are expressed in achieving high performance in that attribute.

c) Determine the appropriate combination of descriptive texts that relate to an individual's performance profile.

d) Determine the appropriate combination of descriptive texts that relate to an individual's performance goals.

e) Determine the appropriate combination of descriptive texts that relate to the different cohort performance profiles for the cohorts in which the individual participates.

f) Present that set of appropriate descriptive texts in a predefined format that collectively constitutes the individual's Personalized career analysis.

In another embodiment, a person ownership of their reputation is guaranteed by PAM system. The features are:

a) All data and review related to an individual person are associated with an account owned and managed by that person. Organizations that use PAM gain access to these scores and ratings for reporting and performance management purposes, however the association between a person and their account is dictated by the person.

b) In some implementations person would then be free to share with, or restrict access to, their performance data (some employers may require access to performance data as a matter of process, but this is not inherent to the design of the PAM).

c) In contrast, existing HR performance evaluation systems data are not generally available to the individual being reviewed outside the scope of their employment, and indeed employee are often restricted from sharing the information within those reviews due to confidentiality agreements.

d) The proposed system of reputation differs from other existing systems by admitting only feedback from authenticated interactions involving two parties where there is evidence of the interaction in the form of a calendar invite, email, electronic message and support ticket

In one embodiment, PAM provides a method for obtaining performance feedback The system creates a superior method of obtaining feedback by:

a) Identifying an interaction by collecting data from person's calendar account

b) Characterize the interaction based on data from the calendar event

c) Select a relevant feedback question based on the characterization of the interaction

d) Deliver the question immediately following the interaction to the feedback giver In another embodiment, considering the performance goals for the persons PAM feedback system differs from currently existing feedback systems based on method of collection:

Collecting based on an authenticated interaction via calendar.

Collecting immediately/in real time.

Collecting based on the characteristics of the interaction.

In one embodiment, PAM provides an effective structure for collecting performance data. The methodology used are:

a) Define a set of values, for example many organizations and individuals do this today with mission, vision, and values statements.

b) Each value is decomposed into a set of competencies that when demonstrated support the value.

c) Define a set of characteristics of feedback that provide reliable evidence of high performance in a given competency such as:

Feedback pertaining to a recent interaction.

Based on a competency likely to be on display during that interaction.

Pertinent to a value around which an individual has a development goal.

Where the party leaving feedback is able to prove relevant feedback on the competency.

For example, within ACME Company, the value of “Bias for Action: Ask Forgiveness not Permission” has been defined as a value the organization wishes to promote. A set of competencies that are exhibited by people who excel at this value are identified—for example by interviewing top performers, or by surveying leaders within the organization, or by reviewing published academic research on the practices and working styles that align. For the sake of illustration assume that the identified competencies that support this bias for action value are:
I. Conveys disagreement directly when necessary.
II. Capable of resolving challenges independently.

d) PAM can effectively identify situations where these two competencies are likely on display by considering:
I. What interactions will these competencies be on display—for example:
II. By considering the meeting archetype—a weekly team meeting might be a good place to look for evidence of individuals who have resolved challenges independently (by presenting a solution in the meeting, rather than by bringing a challenge to the meeting), whereas a product launch readiness go/no-go decision making meeting would be a good place to look for evidence of appropriate direct disagreement between the head of marketing and the head of technical support.
III. By doing natural language processing on meeting invites looking for phrases such as “make a determination” or “resolve whether to” to identify cases where disagreement is likely, or “demonstrate approach” or “review solution” for cases where a problem may have been resolved independently

e) PAM evaluates the relationships the participants in this interaction have and how that might inform their ability to provide useful feedback on the competency—for example if a supervisor is present in an interaction they would likely have good feedback on whether an individual resolved a challenge independently. By the same token a supervisor may be a bad PAM to request feedback on whether an individual conveys disagreements directly—as most people are less inclined to openly disagree with their supervisor than with others.

In one embodiment, PAM allows across many persons to identify career trajectory over time and create a relationship profile. The methodology used is as follows:
PAM maintains a time based relationship profile; achieved by observing the job title of an individual and those they interact with over time, noting the changes in job title as contacts are promoted, move between companies, etc.

Example: A manager of product marketing with 5 years of job experience wants to become a VP of Products at a Fortune 500 company. PAM shows that not only the typical performance profile of a VP of Products at a Fortune 500 company, encompassing the competencies and skills of such a PAM, but also evaluate the cohort of VP of Products at Fortune 500 companies who in the past were a manager of Product Marketing, and then show the path between those two roles:
How long it took?
What the skill profile was like at the Manager level, and how it changed on the way to the VP of Products title?
How many intermediate promotions or titles existed, and the duration in each of those stages?

A Display Module 210 may display notifications (which may be generated by a Communication Module 214) reminding a person to review display results from time to time. Different notifications may be presented to different persons according to their roles.

The system may allow a person to select a particular category (activity type, performance attribute or other category) to see aggregate information collected by an analysis module, including total number of responses, overall ratings, and comparisons against previous periods, against other types of activity or against other cohort types.

A Management Module 212 may provide the person the ability to manage settings in the PAM, system templates, performance goals and recommendations and other attributes of the PAM. An Input Module 202 allows a person to input performance goals either for himself or for another person such as a PAM reporting to him within an organization. The Management Module 212 may allow a person to edit an existing goal based on the person's role. As an example, an individual person may take a goal set by her manager and make an edit to create an individual performance goal. The system may allow the individual person to mark the edited goal as private or display it to her manager, or send it to her manager for approval. The system may store a history of versions of a goal.

A Management Module 212 may map a goal to a set of analysis results. As an example, a goal of “75 percentile of Cohort X” may be mapped to a calculated performance dashboard for Cohort X. In performing this mapping function, the system may use one or a combination of techniques, including:

Controlled Inputs, where the person must ‘build’ a goal from a set of defined values. As an example, the system may require the person to first choose whether the goal is an activity goal, a profile goal, a feedback goal, or a comparison goal. Based on the choice, the system may then require the person to select from a series of options (# of times, over what period of time, activity selection) to ‘build’ the particular goals.

Natural Language Processing, where the system uses available natural language processing techniques and algorithms to analyze the goal and suggest most likely mappings.

Person controlled, where the system allows the person to set the mapping himself, or change the mapping proposed by the system.

A Management Module 212 may display notifications of new goals added or edited, or of reminders about existing goals. Different notifications may be presented to different persons according to their roles.

A Management Module 212 may allow a manager, teacher or other assessor to view feedback templates and edit them to align them against specific performance goals. For example, the system provided template for a sales PAM might solicit a customer for ratings on their referenceability, but the Management Module 212 may permit a Manager to instead or additionally ask for a rating on the sales PAM's perceived honesty.

Minimizing the number of total required input in any feedback request is paramount to mitigate evaluation inertia, so Management Module 212 may flag feedback template questions which are not aligned with performance goals set by a person.

A Communication Module 214 may be responsible for communication between devices within the PAM such as between the application on the person's device and other devices such as the system's server or the database, or between the person's device or the server on one hand, and the various third-party applications referred to herein, such as email, SMS, IM, calendar, and CRM systems, on the other hand. A Communication Module 214 may deliver notifications, updates, reminders and other communication to a person in support of the functions performed by the PAM.

Communication between the applications and devices within and outside the PAM may be carried out using AJAX requests sending JSONP requests and receiving JSON format responses. Communication may be performed with HTTPS TLS encryption to maintain privacy and data integrity. The Communication Module 214 can automatically synchronize newly inputted or generated data with the central server in the background, to ensure agreement between the application on the person's device and the system's server. The application will function just as well in off-line mode as in on-line mode. All new data can synchronize with the server when the device regains network connectivity

Communication between the server and third-party applications may use public or private APIs for such applications. Examples of such API's are commonly known. Some examples include: Microsoft Exchange (2007 or higher, including Office365)—EWS (Exchange Web Services API), Gmail—Gmail API, Yahoo Mail—Yahoo Mail Web Service, Salesforce.com CRM—Salesforce.com SOAP API etc.

A Server Module 218 may manage and coordinate several of these modules for the PAC system. A Cloud Management Module 220 may be used for managing cloud based enterprise system for larger usage area and for storing massive amounts of data.

All modules may be highly optimized to render as quickly as possible, record input and render the next screen as quickly as possible, and contain intelligence for the format of the display that is preferred for that particular person or that particular person role. As an examples, all relevant data for a particular system interaction may be transferred from the system's server to the person's device, reducing continuous back and forth device-server communication that can slow down a person's experience of the system and discourage real-time inputs or overall system use. As another example, the PAM may detect the display formats a particular person continues to view and automatically default future displays to those formats.

Various data formats that can be incorporated are, but not limited, video, audio, graphics, and text files, mesh wireless network data, robotic data, e-computer/TV, server data, desk top computer, wearable clothing sensor data, mobile device data, software component data, applications such as email, web data (e.g., HTML, CSS, JavaScript, XHTML etc.), calendar, games CRM, ERP, SFA, blogs, social media, chats, newsfeeds, social streams or feeds, RSS, movies, animation, radio, machine data, sensor, RFID, DSP data, graphics, images, document, news, media, advertising, wiki, blog, augmented reality, implant data, software components (e.g., compiled or uncompiled), software scripting language data (e.g., compiled or uncompiled) and commerce data. Examples of other data formats such as corporate data (audio recordings, social media content, image, raw data, sensor data and/or video streams, ERP, content, document and information management, Salesforce.com (e.g., sales/service cloud, chatter), Directory (e.g., Active Directory), LDAP, social media content like the Twitter “firehose” or profiles from LinkedIn, presence, directory, email servers, Internet teleconferencing (e.g., Webex, Telepresence, video sharing, publishing, sensor data, and images type of software, enterprise data, internet data, social media data, raw data and stored metadata such as .xlsx (of Microsoft Excel), .docx (of Word), .pptx of Microsoft PowerPoint), .rtf, .pdf, SMS, tweets, chats, RSS, DSP, emails, Web content (HTML, CSS, XHTML), raw data, sensor data, web feeds or news feeds, image, sensor data and /or video streams, consumer and entertainment data, audio data, game data, animation data, augmented reality enrichment from wearable and or mobile devices, input from sensor or camera, QR codes/bar scans/RFID, near field or wireless input, sensors, home appliances, component of a graphic and/or video segment, implant data(e.g., hearing aid), financial data, marketing data, insurance data, project data, sales data, service and support data, social data, scientific data and health care data, GPS, software programming data, binary data etc.

FIG. 13 shows the PAM Inputs and Outputs 400 in a different but logical way. System inputs are classified and different outputs such as activity map and benchmark dashboards are presented to person. In one embodiment, system inputs 1302 namely contacts, calendar, emails, and other data are input to classification module 1306. Classification module 1306 uses activity types 1304 and cohort types 1308 to provide activity maps 1310 and benchmark dashboards 1312.

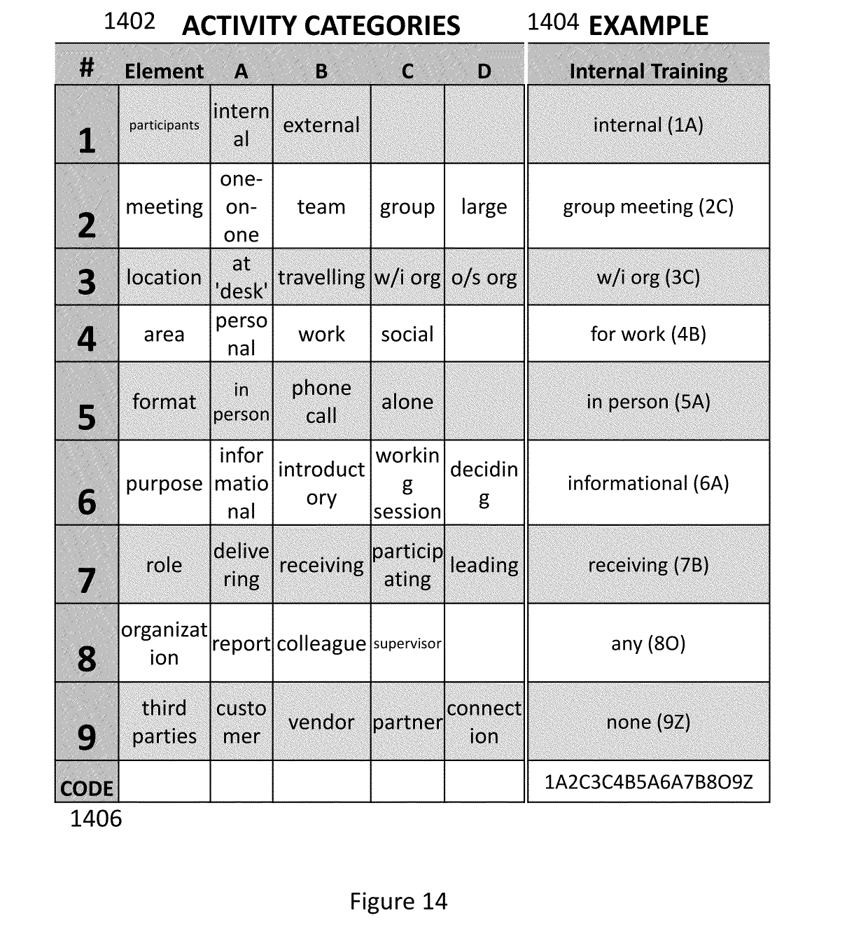

FIG. 14 shows different choices the person may have while elect their activity categories and some examples 1404 where they can get help for their activity categories 1402. FIG. 14 shows an example of how different activity types may be generated by PAM. From the results of the classification modules, the analysis module 206 may generate various benchmark dashboards showing where the person's profile stands as compared with others within selected cohorts. The method for continually assessing performance metrics, comprises of a few steps such as detecting that a person has been involved in a specific activity and categorizing the interaction of the PAM in the specific activity.

As an example, the person can choose to see a benchmark dashboard of how his salary compares with other Finance Directors or how his title compares with others in medium sized technology companies with 10 years of experience. Using other information that can be collected from person profiles, the Analysis Module 206 can show other benchmarks such as the how recently persons from the same cohort that have taken on new roles, or what an general performance profile looks like from an aggregated view of persons from the same cohort.

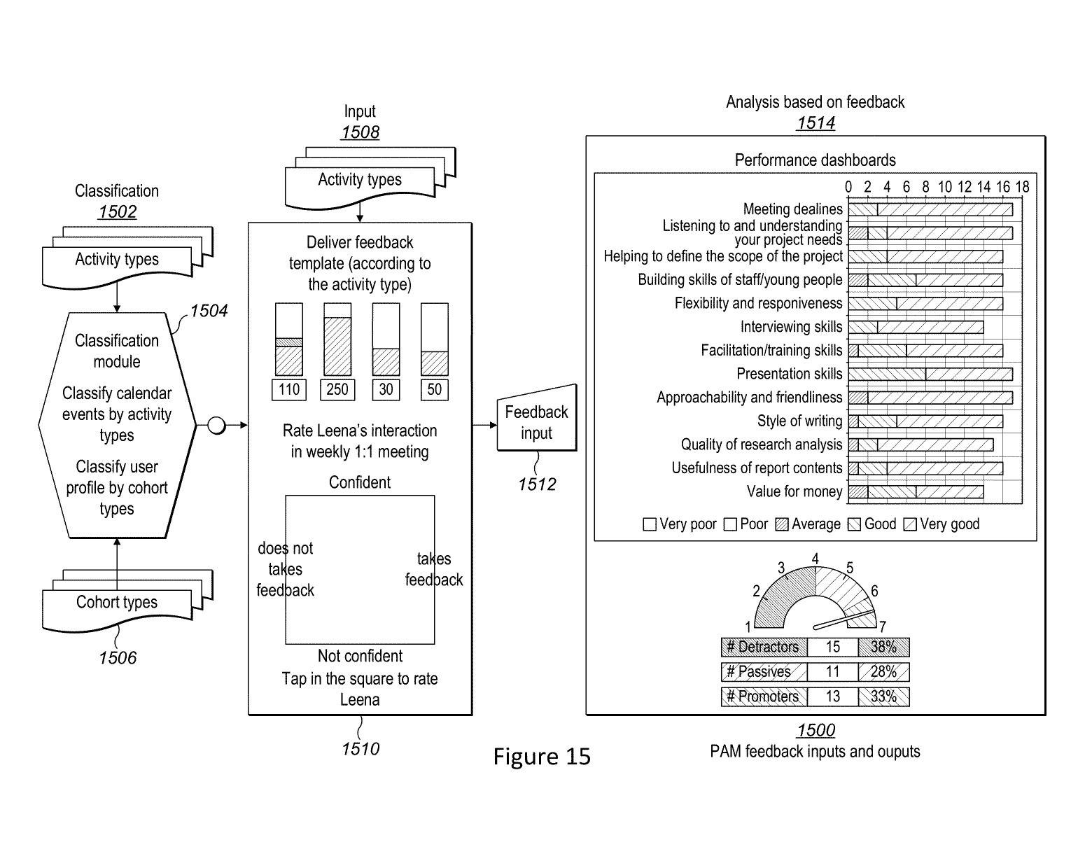

FIG. 15 shows the PAM feedback Inputs and outputs 1500. The classification leads to input by the peers or the supervisor or the PAM specific algorithm to calculate automatically and display feedback to the person. In one embodiment, classification module tracts activity types 1502 and classifies calendar events 1504 and matches cohort types 1506. The feedback templates 1508 provided as input is used to create feedback template and performance analysis report 1510. This is supplied as feedback input 1512. The analysis based on feedback is provided through dashboard metrics 1514.

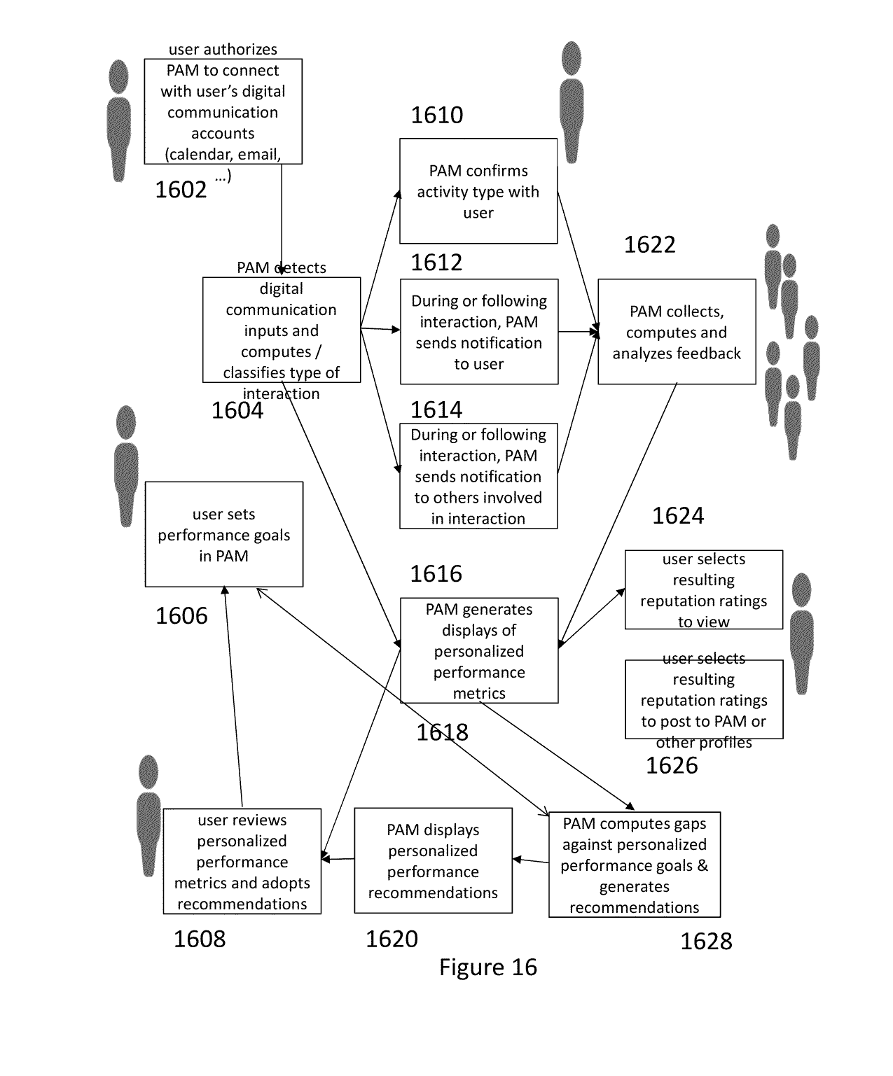

FIG. 16 is an example block diagram of a person flow of the PAM 100. A person may interact with a PAM application 200 through various person interfaces displayed on the person's computing device (including a mobile device). Part or all of the PAM application 200 may be installed on the person's device or may be installed remotely and accessed by the person's device through a Network 102.

A person may authorize PAM application 200 to interface and communicate with other accounts and devices of the person through interface 1602 in order for the PAM application 200 to collect relevant data. Step 1610 indicates an example where a person may manually categorize an interaction in the PAM application analysis. The PAM application may prompt the person to manually categorize a calendar event in certain circumstances, such as where there are conflicting items on the person's calendar.

A person may request a display of his person profile from the PAM application 200, which may include performance and reputation ratings, rankings and benchmarks, 1608 and 1606, generated by the PAM application 200? A person may set configuration settings on his profile so that certain elements of his profile are made ‘public’ and therefore viewable by any person within the PAM (a public reputation rating), 1626. The PAM may be configured so that profile elements cannot be set to ‘public’ until rated by a sufficient number of people. Alternatively, the PAM may be configured to display the total number of raters alongside the publicly rated element in the person's PAM profile. A person may review other public profiles of other persons stored and displayed in the PAM 100.

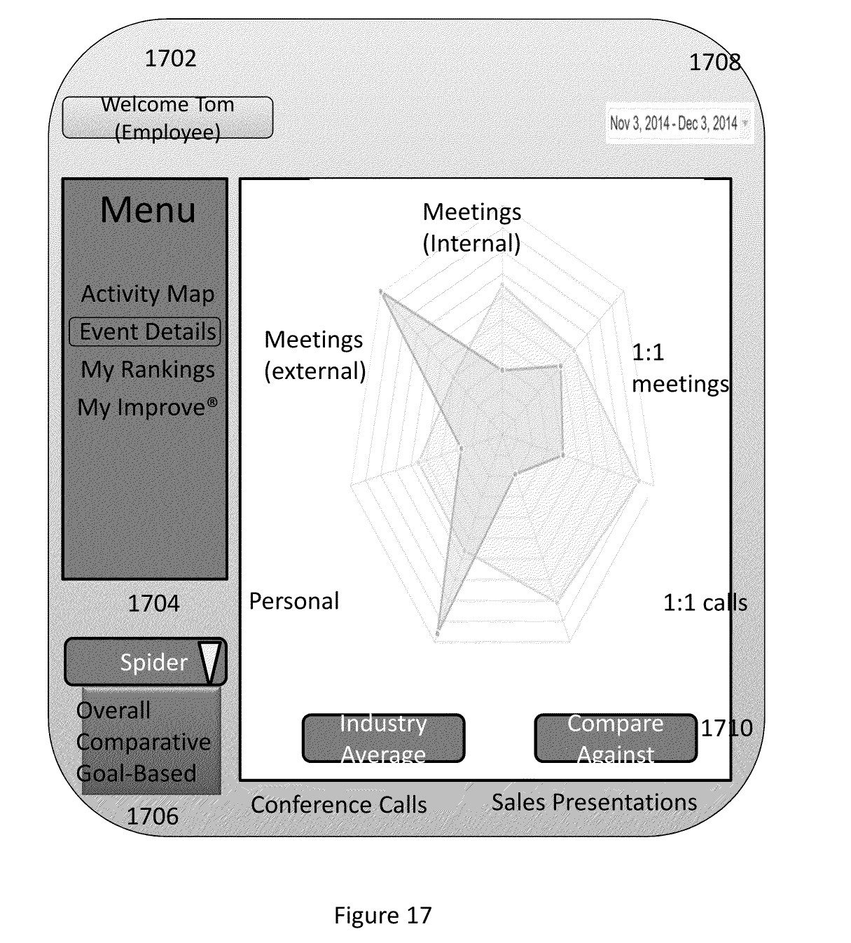

In an embodiment, a person may request a display of his own activity map in the person's preferred display format. In one embodiment, FIG. 15 is an example of a person's activity map generated by the PAM application 200 displayed in a spider web format. A person may request a display of activity maps for different cohort types stored and displayed in the PAM 100 and generated from data collected by PAM from multiple persons. As an example, a person may be presented dashboards of ‘activity maps’ for different career profiles such as hospital workers, Chief Marketing Officers of public companies, small business retail owners, and the like. A person may request a comparative display of his activity map against a calculated activity map of a particular cohort. FIG. 17 is an example of such a comparative display.

The PAM application 200 may restrict access to certain dashboards unless the person inputs additional information about the person's profile (industry, employer, and for-profit/non-profit, years of experience etc.) to ‘unlock’ more levels of analysis.

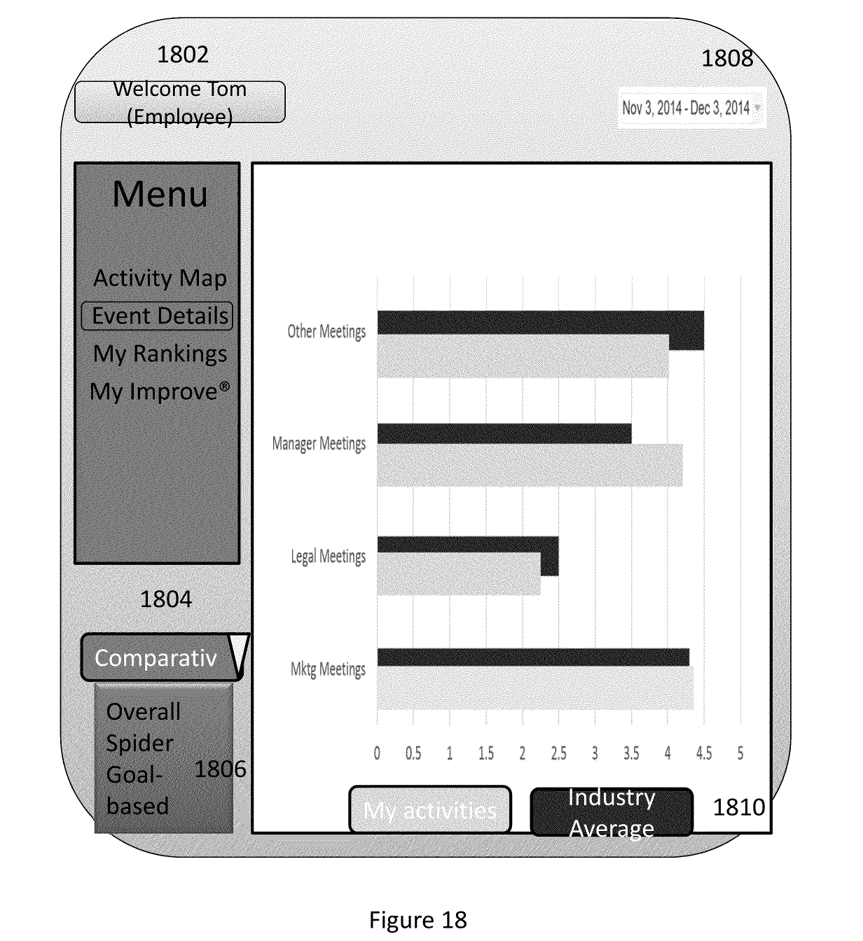

In one embodiment, FIG. 17 shows yet another GUI for showing the activity to the person such as external meeting, conference calls and meetings that are happening internally. All these activities are being measured and the output is provided to the PAM for performance evaluation or performance metrics for the person. Based on the effectiveness of the activity the person may change the activity to enhance his or her performance. In another embodiment, FIG. 18 allows the person to compare their performance against the industry average for various activities and displays it in a nutshell as graphical display.

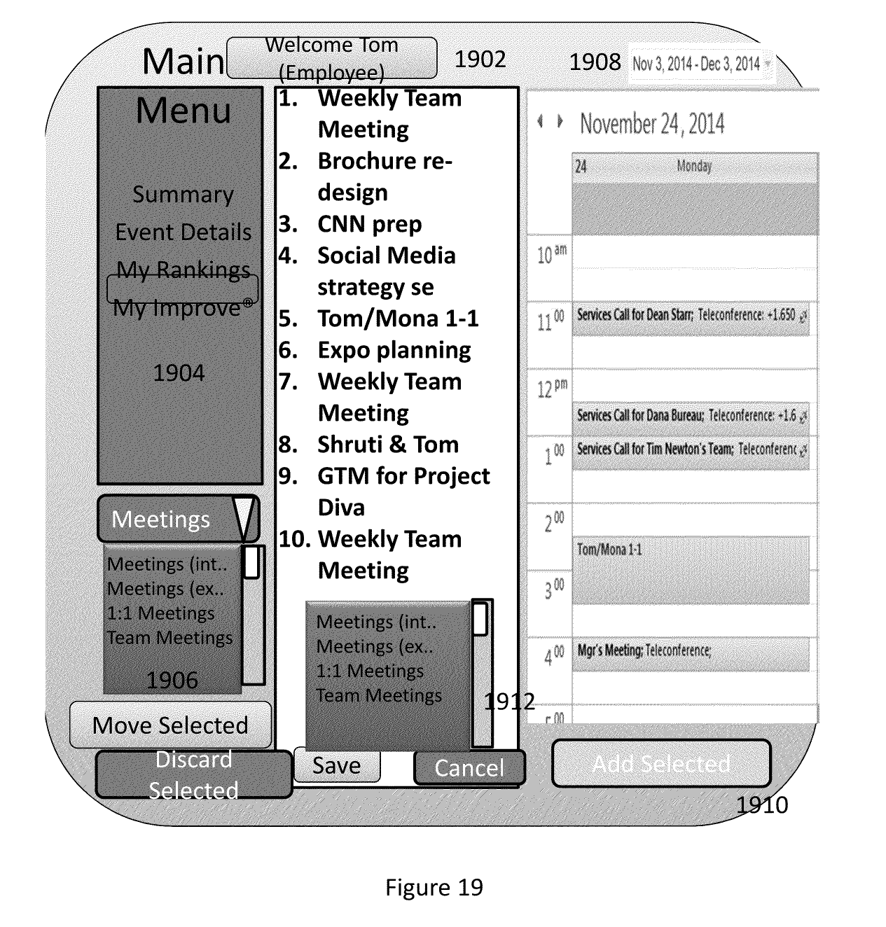

A person may drill down into his Personal activity map and request a breakdown of the categories of activities or interactions over a specified time period, such as shown in an example display in FIG. 19. A person may interact with the detailed data by correcting, removing, adding, flagging or commenting on items. In one embodiment, the person as an employee is identified 1902. In another embodiment, the identification could be a group. The date is specified in 1908. The meeting details is given 1906, which can be edited 1912 and saved. The interface allows complete flexibility to manage the marketing meetings.

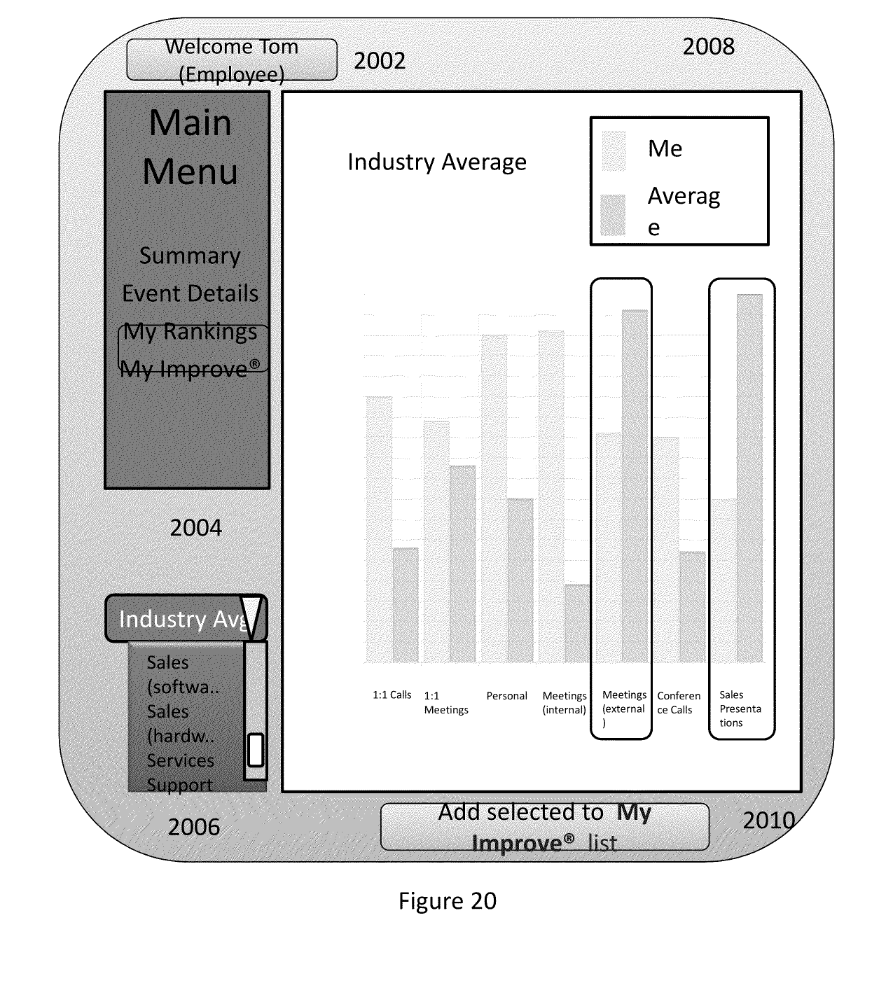

A person may request a comparison display of his activity map compared with a chosen cohort. The person may set targets within the PAM application based on the results of these comparisons, which will be stored in the PAM application as goals for the person. The PAM application may automatically recommend goals based on the results of these comparisons for the person to set as targets. FIG. 20 shows an example display of how targets may be identified based on comparative results. A person may receive a notification on his device from the PAM application requesting that the person rate his own participation in an interaction or another PAM's participation in an interaction.

A person may view his Personal performance dashboards and trending data, including:
cumulative ratings of how he has rated himself by different kinds of interactions
cumulative ratings of how all others have rated him by different kinds of activities
Cumulative ratings of how he has rated others by different interactions, by time period, by individual PAM rated, or by some other attribute stored in the PAM.

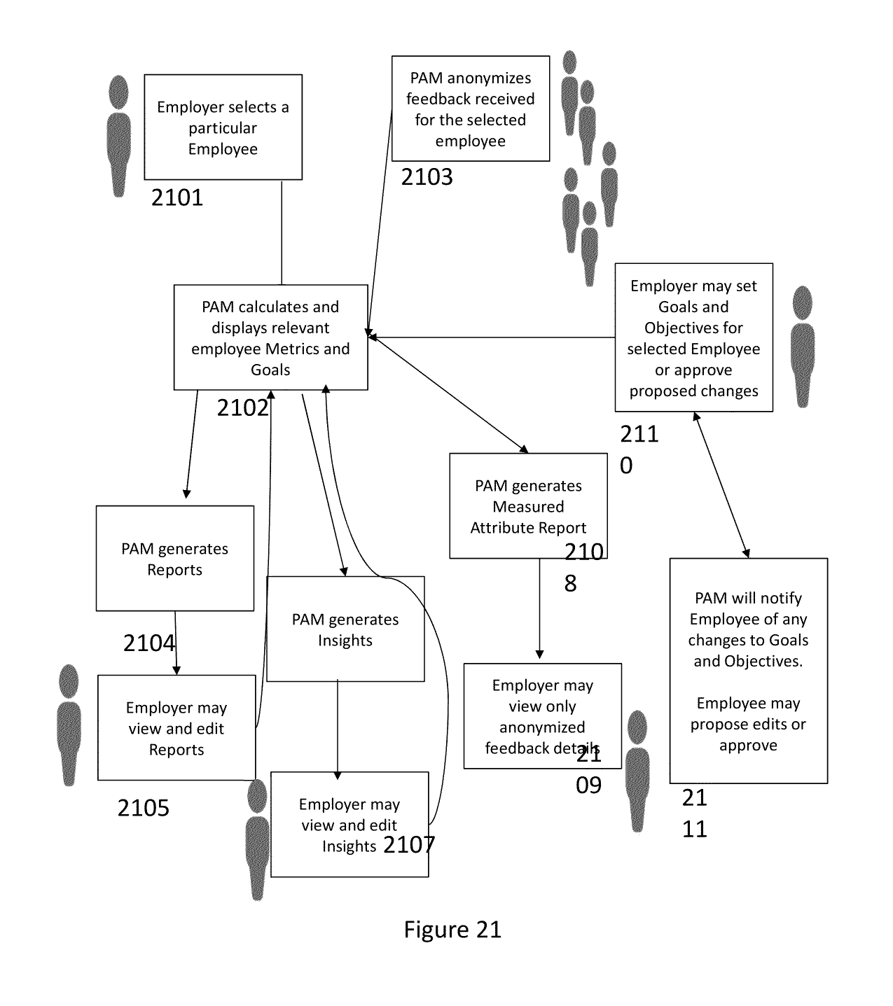

The PAM application may include particular displays directed at employers or group managers. FIG. 21 shows an example flow of an employer flow of PAM 100. For the purposes of this example, we refer to an employer-employee relationship; however it can be appreciated that this flow can apply to any relationship where one PAM is overseeing the performance of another. An employer may interact with a PAM application 200 through various person interfaces 2101, 2105, 2107, 2109, and 2110 displayed on the employer's computing device (including a mobile device). Part or all of the PAM application 200 may be installed on the employer's device or may be installed remotely and accessed by the employer's device through a Network 102.

The Employer may select an active Employee person through an interface, and the PAM may calculate and present the employee status interface 2102 populated with relevant data for that Employee. This interface may show the aggregated performance metrics and statistics of employee performance for each measured attribute, the trend of each measurement, comparisons of current versus past performance, and an on-going report showing employee performance to date. The Employer may view and edit reports generated by PAM 2104 through a reports interface 2105.

The Employer may view and edit or add annotation to insights calculated and generated by PAM 2106 through an insights interface 2107. Insights might be a result of comparing employee scores against measurable business outcomes such as sales growth, cost reduction, etc., and professional outcomes such as promotion or merit based pay increases and bonuses. This data can be used to correlate the actual behaviors and strengths that accompany business and professional success (which may be different than anticipated).

The Employer may choose to view a more detailed measured attributes report through interface 2109. This report may show detailed feedback analysis collected about a given employee for a given activity or activity category Settings in the PAM may require that the Employer does not see who gave the feedback, allowing the feedback providers (2103) to be anonymous and thereby more likely to provide accurate and honest feedback. Settings may permit an Employer to view the number of feedbacks received for a given activity type or attribute type. The Employer may choose to view, create, set or edit goals or objectives for an employee through an interface. Goals may be chosen from a pre-defined set of goals in the PAM so that their achievement can be compared against other employees, cohort types, or other attributes in the system.

The PAM may notify an employee about any changes to goals or objectives through interface 2111, allowing the employee to review, edit, annotate or approve changes. The PAM may notify the employer of any employee interaction with the goals and objectives managed through the PAM. Trend graph view of each goal, goal prioritization, over/under, and other types of HR metrics may be added to the PAM for reporting purposes.

As a method of using PAM A method for a performance analytics solution populating a specific metrics for a person to achieve in a specific time is done by recruiting a peer, mentor, supervisor, performance manager, or another person to provide feedback for creating performance metrics data for the person. Calculation of the performance metric data for the person using inputs by the person and feedback from the peer, mentor, supervisor, performance manager, or another person, wherein the feedback is anonymous; and that result is displayed as an interactive report in a graphical user interface for the person, mentor, supervisor, performance manager, or another person.

Comparing the specific performance metric data of the person to performance metric data of groups of people, or the overall industry is done over a period of time. Calculating an overall impact of a multiple person performance metric data for determining a performance health of a group is useful for industry wide comparisons.

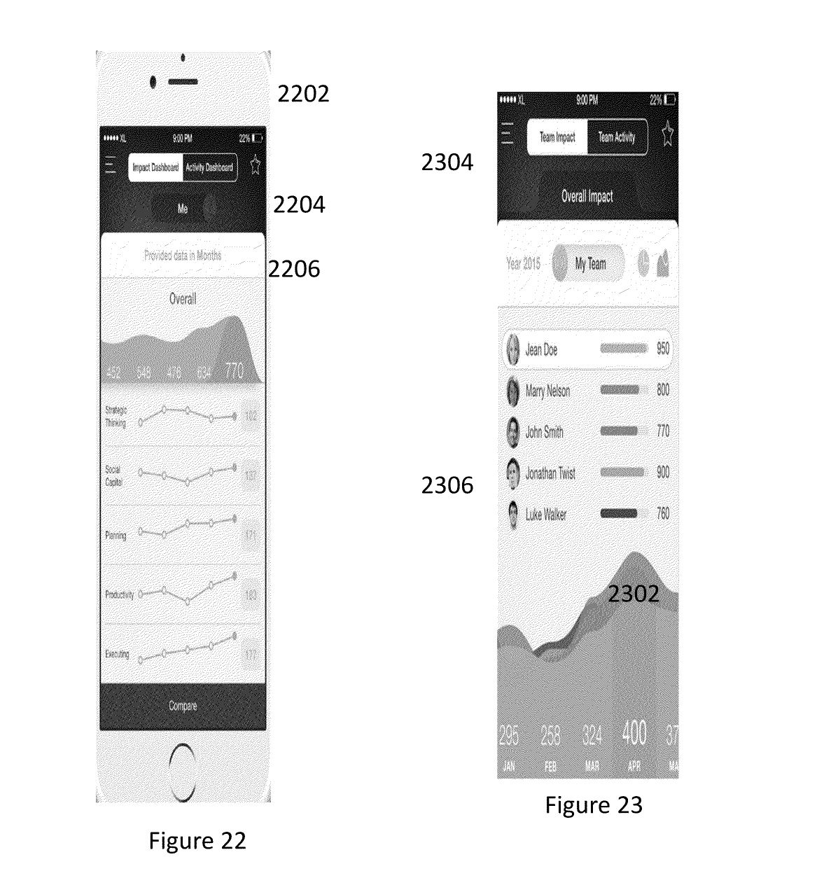

FIG. 22 provides an embodiment of obtaining aggregated feedback using PAM. PAM makes performance management an everyday activity. Each employee will review aggregated feedback from everyone they interact with 2202, not just their manager, and not just people within their company. In one embodiment, the questions are contextualized by the type of interaction. In another embodiment, feedback from multiple sources in various contexts 2206 on the same standard question set enables personalized analytics. Dashboards 2204 are displayed with various metrics 2206 displayed enabling personalized analytics. Collection of data that is available for performance development resources for a cohort and processing recommended actions or goals of all people in a cohort to allocate available performance development resources based upon the processed recommended actions or goals is done using PAM. The resources are allocated in a manner to achieve the greatest impact on performance of a person or of the cohort based on performance data collected for persons identified having high performance indicators.

FIG. 23 provides an embodiment where a manager can easily monitor the strengths and weaknesses of his or her team displayed through the dashboard 2304. Various team member performance scores 2306 are displayed and their performance based on time period 2302 is shown in the graph. In another embodiment, automated performance summaries based on aggregated reviews from variety of people are gathered. The data ranks the employees and analyzes strengths and weaknesses of each employee. It removes the burden of being the judge from the manager providing areas to focus with the employees instead of collection efficacy.

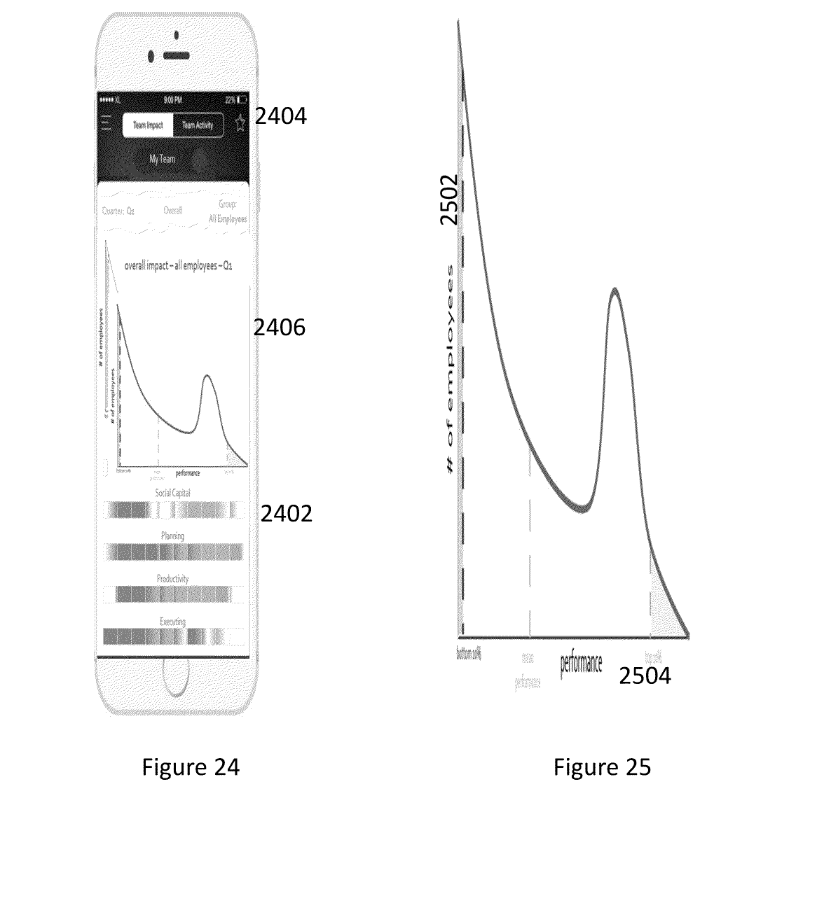

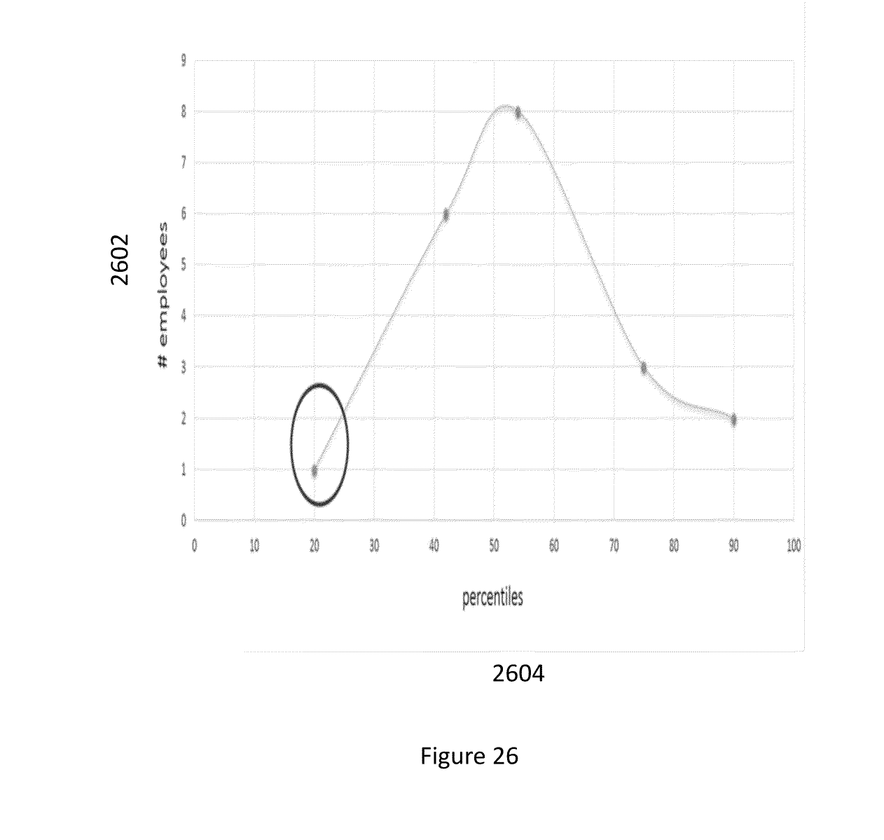

FIG. 24 illustrates an embodiment of monitoring the performance health of the workforce across the organization. In one embodiment, organizations will have visibility into performance health of their workforce at any time. In another embodiment, transparency into pockets of workforce at the granularity of individual, team and project can be monitored through dashboard 2404. The performance of the team 2406 is given using a graph with metrics 2402 monitored separately. In another embodiment, holistic display provides transparency into relationship biases. In another embodiment, data and tools to accelerate the growth and development of workforce and organization effectiveness is provided by PAM. FIG. 25 illustrates an embodiment where organization's performance is monitored as a graph provided by analytics engine in PAM. The graph shows the performance 2506 over number of employees 2502. FIG. 26 illustrates an embodiment where an individual manager can monitor his or her team's 2602 performance 2606.

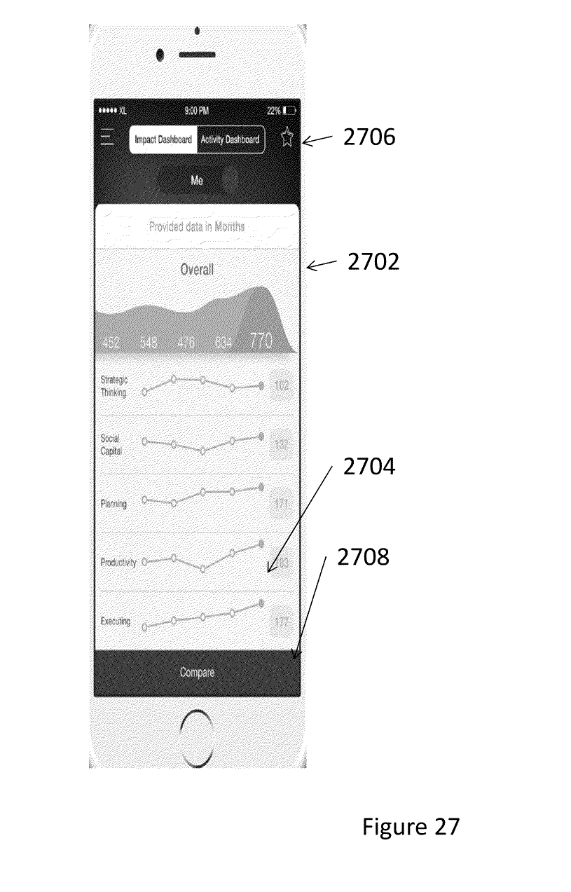

FIG. 27 illustrates an embodiment of PAM providing feedback and analytics for Personal individual impact seen through dashboard 2702 and 2706. In another embodiment, the proposed system provides individual's performance compared to peers within a job role across the company, industry and market. Correlations 2704 and metrics 2708 can track specific to goals set by managers related to performance incentives such as bonus and promotion.

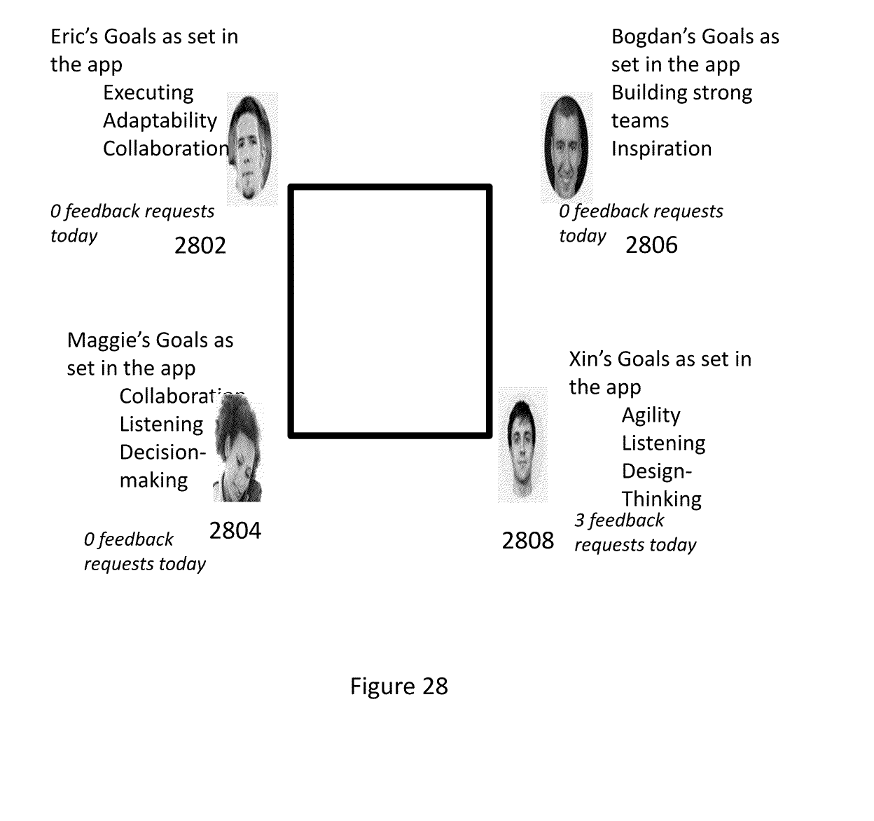

FIG. 28 illustrates an embodiment of how PAM intelligently determines appropriate feedback requests in real-time during or immediately following an interaction. In this embodiment, each participant in the interaction has a goal set for feedback in PAM. For example, Eric's 2802 goals are Execution, Adaptability and collaboration. Bogdan's goals are 2806 team building and inspiration. Maggie's 2804 are collaboration, listening and decision making and Xin's 2808 being agility, listening and design-thinking.

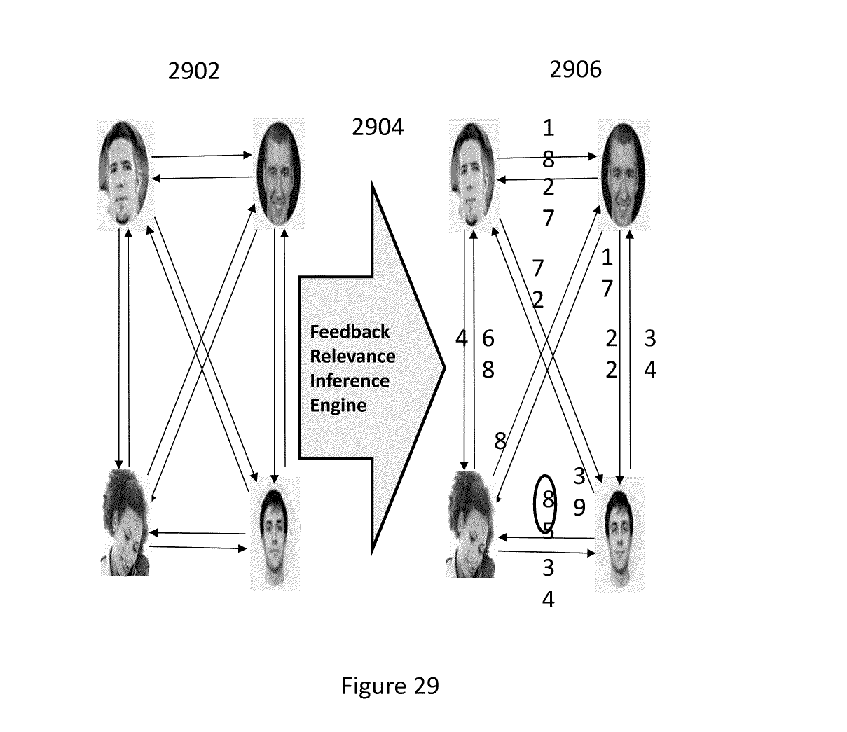

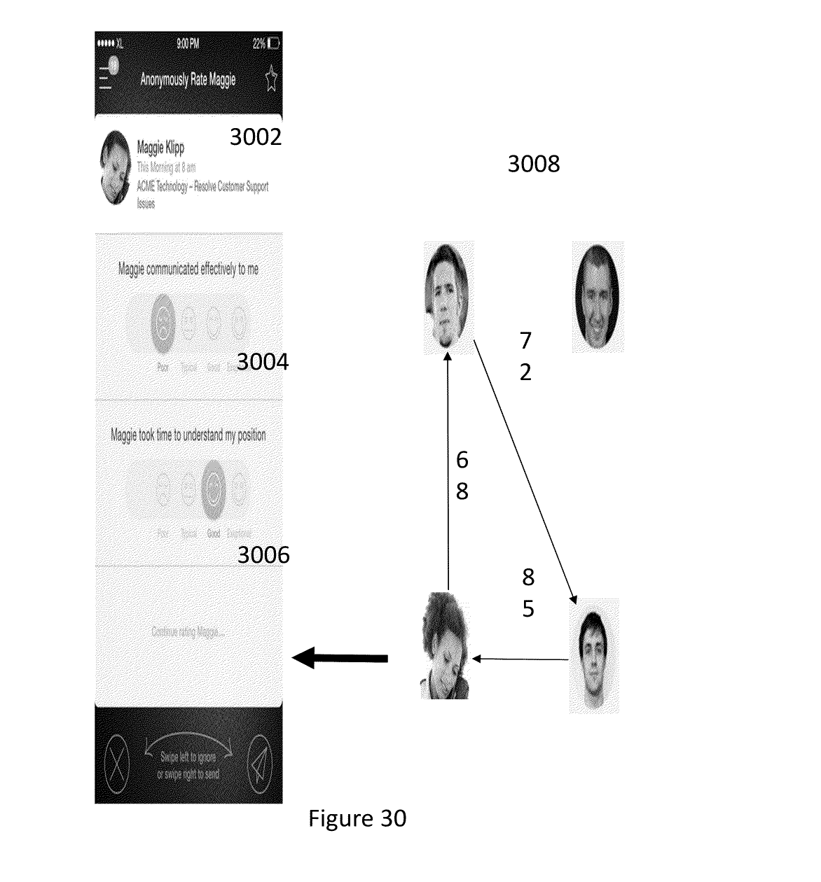

FIG. 29 shows the intelligent system backend of PAM obtaining feedbacks and ratings from every participant 2902. The inference engine 2904 in the backend heuristics tracks the feedback requests 2906 made that day and the number of ratings provided by the PAM to the receiver. FIG. 30 illustrates an embodiment where the feedback graph is simplified for one participant in the interaction, Maggie. It can be seen, three feedback requests made as a result of this meeting of which one of these requests is to Xin about Maggie. The person interface 3002 shows that an individual 3004 can be targeted for feedback anonymously 3006.

### INDUSTRIAL APPLICABILITY

There are very significant application and superior benefits for the calculating performance metrics to improve for an individual. More specifically the present invention describes a more effective method and system for obtaining data regarding a person's daily activity and interactions, and a novel method and system for processing such data using system templates to generate timely, accurate, relevant and actionable performance metrics that workforce participants can use to guide them towards better career outcomes. This technology may be used for other applications but not limited to, such as product launch, person feedback, and customer need evaluation etc.

What is claimed is:

1. The method for continually assessing performance metrics, comprising:
detecting that a person has been involved in a specific activity;
categorizing the interaction of the person in the specific activity;
generating one or more of a feedback questions based on the categorization;
sending an automated request to respond to the generated feedback question to one or more persons who were involved in the specific activity;
receiving a response to a feedback request;
processing the response received from the feedback request with other responses received over a period of time;
generating a performance metrics data from the processing of responses using a processor; and
presenting the performance metrics data as an interactive display on a hardware having a processor.

2. The method of claim 1, wherein detecting that the person has been involved in the specific activity is authenticated by collecting a data from the person's personal productivity accounts or from the person's personal computing device.

3. The method of claim 2, wherein categorizing the interaction of the person in the specific activity is automatically performed using the data obtained from the person's personal productivity account or from the person's personal computing device.

4. The method of claim 1, wherein one or more of the feedback question is generated in a real time, immediately during or following the completion of an interaction, or after a period of time or a project completion.

5. The method of claim 1, wherein one or more of the feedback question is generated from a database of questions and selected by matching an attribute associated with the question to an attribute associated with the person and the interaction.

6. The method of claim 1, wherein one or more of the feedback question is generated from a database of questions and selected heuristically.

7. The method of claim 5, wherein processing the response received from the feedback request involves aggregating feedback related to specific attributes to create rating scores by attribute over a period of time.

8. The method of claim 1, wherein the performance metrics data generated from the processing of responses includes a comparison of data generated for the person against data collected for a cohort of people, and wherein the performance metrics data presented is displayed in comparison to aggregate performance metrics data for the cohort of people.

9. The method of claim 1, wherein the performance metrics data generated from the processing of responses is combined with other performance metrics data generated for that person over time to generate a reputation profile for that person.

10. The method of claim 1, further comprising:
automatically calculating recommended actions or goals for the person based upon the performance metrics data generated; and
presenting the recommended actions or goals in an interactive display.

11. The method of claim 8, further comprising:
calculating recommended actions or goals for the person based upon the comparison data generated; and
presenting the recommended actions or goals in an interactive display.

12. The method of claim 1, further comprising receiving a set of attributes; and
generating questions that provide reliable evidence of an attribute; and
wherein the one or more feedback questions are generated by matching the attributes associated with the generated question to the attributes associated with the person and the interaction.

13. The method of claim 11, further comprising:
collecting data of available performance development resources for a cohort;
processing recommended actions or goals of all people in a cohort;
allocating available performance development resources based upon the processed recommended actions or goals.

14. The method of claim 13, wherein the resources are allocated in a manner to achieve the greatest impact on performance of a person or of the cohort based on performance data collected for persons identified having high performance indicators.

15. The method of claim 1, further comprising:
generating descriptive text for each performance metrics data; and
presenting the descriptive text in a predefined format in an interactive display.

16. A system, comprising:
a processor to process a performance analytics solution for generating performance metrics data;
a knowledge base database to provide a historical and current data for a heuristic calculation of the performance metrics data for a given person, a peer, a cohort and industry wide;
an input module to receive input about a person, interactions of that person, and feedback about the person's interactions;
a classification module to classify the input from the input module to create feedback questions;
a communication module to collect feedback responses from questions generated as a result of the classification module;
an analysis module to perform calculation on the feedback responses either on its own or in combination with other data from the knowledge database to generate performance metrics data; and
a display module to present the performance metrics data in a graphical person interface.

17. The system of claim 16, further comprising:
a recommendation module to provide input to the analysis module, wherein the input for the recommendation module is received from at least one of a person, mentor, supervisor, peers, performance managers, external software or databases.

18. The system of claim 16, further comprising:
an intelligent backend system to provide automatic performance review documentation, time management docket, correlation based feedback, effective feedback collection, causal career relationships and commitment analysis for the performance analysis solution.

19. The system of claim 16, further comprising:
a relevance inference feedback engine to provide an interactive evaluation display based on the performance metrics data for the person and comparing with other relevant groups.

20. The system of claim 16, further comprising:
a performance dash board to display a feedback input from a person, peer, supervisor, coach, mentor or performance manager.

21. A method for a performance analytics solution, comprising:
populating a specific metrics for a person to achieve in a specific time;
recruiting a peer, mentor, supervisor, performance manager, or another person to provide feedback for creating performance metrics data for the person;
calculating the performance metric data for the person using inputs by the person and feedback from the peer, mentor, supervisor, performance manager, or another person, wherein the feedback is anonymous; and
displaying an interactive report in a graphical person interface for the person, mentor, supervisor, performance manager, or another person.

22. The method of claim 21, further comprising:
notifying the person, peer, mentor, supervisor, performance manager or other person if there has been any change in the specific metrics for a given person.

23. The method of claim 21, further comprising:
comparing the specific performance metric data of the person to performance metric data of groups of people, or the overall industry, and over a period of time ; and
calculating an overall impact of a multiple person performance metric data for determining a performance health of a group.
